(19) United States
(12) Patent Application Publication
(10) Pub. No.: US 2025/0330765 A1
(43) Pub. Date: Oct. 23, 2025

(54) RESCALING AUDIO SOURCES IN EXTENDED REALITY SYSTEMS BASED ON REGIONS

(71) Applicant: QUALCOMM Incorporated, San Diego, CA (US)

(72) Inventors: Isaac Garcia Munoz, San Diego, CA (US); Alex Tung, San Diego, CA (US); Andrea Felice Genovese, Brooklyn, NY (US); Graham Bradley Davis, Seattle, WA (US)

(21) Appl. No.: 19/182,313

(22) Filed: Apr. 17, 2025

Related U.S. Application Data
(60) Provisional application No. 63/636,611, filed on Apr. 19, 2024.
(60) Provisional application No. 63/636,621, filed on Apr. 19, 2024.

(51) Int. Cl. H04S 7/00

(52) U.S. Cl. CPC H04S 7/303; H04S 2400/11

(57) ABSTRACT

In general, techniques are described that enable a device to rescale audio sources in extended reality systems. The device may include a memory configured to store metadata specified for two or more audio elements, where the metadata identifies a respective region in which each of the two or more audio elements reside within a virtual environment representative of a source location. The device may also include processing circuitry communicatively coupled to the memory, and configured to determine that a listener has moved between the two or more audio elements. The processing circuitry may also be configured to rescale, responsive to determining that the listener has moved between the two or more audio elements and based on the respective regions, the two or more audio elements to obtain at least one rescaled audio element, and reproduce the at least one rescaled audio element to obtain an output audio signal.

This application claims the benefit of U.S. Provisional Application No. 63/636,611, filed Apr. 19, 2024, and U.S. Provisional Application No. 63/636,621, filed Apr. 19, 2024, the entire contents of both are hereby incorporated by reference.

### TECHNICAL FIELD

This disclosure relates to processing of audio data.

### BACKGROUND

Computer-mediated reality systems are being developed to allow computing devices to augment or add to, remove or subtract from, or generally modify existing reality experienced by a user. Computer-mediated reality systems (which may also be referred to as “extended reality systems,” or “XR systems”) may include, as examples, virtual reality (VR) systems, augmented reality (AR) systems, and mixed reality (MR) systems. The perceived success of computer-mediated reality systems are generally related to the ability of such computer-mediated reality systems to provide a realistically immersive experience in terms of both the visual and audio experience where the visual and audio experience align in ways expected by the user.

Although the human visual system is more sensitive than the human auditory systems (e.g., in terms of perceived localization of various objects within the scene), ensuring an adequate auditory experience is an increasingly import factor in ensuring a realistically immersive experience, particularly as the visual experience improves to permit better localization of visual objects that enable the user to better identify sources of audio content.

### SUMMARY

This disclosure generally relates to techniques for scaling audio sources in extended reality systems. Rather than require users to only operate extended reality systems in locations that permit one-to-one correspondence in terms of spacing with a source location at which the extended reality scene was captured and/or for which the extended reality scene was generated, various aspects of the techniques enable an extended reality system to scale a source location to accommodate a playback location. As such, if the source location includes microphones that are spaced 10 meters (10 M) apart, the extended reality system may scale that spacing resolution of 10 M to accommodate a scale of a playback location using a scaling factor that is determined based on a source dimension defining a size of the source location and a playback dimension defining a size of a playback location. The audio renderer may be initialized to statically perform this rescaling to accommodate the different sizes of playback locations, which may improve reproduction of the soundfield.

However, while initializing the audio renderers in this manner may improve reproduction of the soundfield by accounting for initial differences between the source location and the playback location, various updates in both listener position (whether in the virtual environment and/or the physical location), virtual scene change, playback location environmental changes (e.g., opening a door, a curtain, etc. in the playback locations), etc. during reproduction of the soundfield may impact auto rescale of audio elements 15 in a manner that reduces immersion or creative capabilities. That is, statically initializing an audio renderer to account for differences between the source location and the playback location may not account for dynamic changes that occur during reproduction of the soundfield, which may reduce the immersive impact of the auto rescale operation (or otherwise limit how audio rescale is perceived).

To overcome these changes, the extended reality system may dynamically perform auto rescale during reproduction of the soundfield. The extended reality system may, as one example, determine that the listener has moved between two or more of the audio elements, which may reside in different or overlapping regions within the virtual environment representative of the source location. The extended reality system may dynamically rescale (e.g., during reproduction of the soundfield), responsive to determining that the listener has moved between the two or more of the audio elements and based on the respective regions, the two or more of the audio elements to obtain at least one rescaled audio element. Rescaling between audio elements may allow for more creative soundfield reproduction while also accommodating a wide range of virtual environments (e.g., including virtual environments produced via a computing device, such as in the case of computer gaming applications).

In addition, the extended reality system may dynamically rescale based on various movements of the listener (either or both in the virtual environment and in the physical playback location), virtual scene change, playback location environmental changes (e.g., opening/closing a door, opening/closing a curtain, etc. in the playback location), etc. during reproduction of the soundfield. Instead of assuming a static rendering accomplished by an initial renderer initialization, the extended reality system may instead initialize audio renderers, and then may continue, during reproduction of the soundfield, to adapt the auto rescale to potentially account for the various changes listed above. In this respect, the extended reality system may perform dynamic auto rescale that may better recreate the intent of the content creator, better account for listener preference, and/or further facilitate a more immersive experience.

In one example, the techniques are directed to a device configured to scale audio between a source location and a playback location, the device comprising: a memory configured to store metadata specified for two or more audio elements, the metadata identifying a respective region in which each of the two or more audio elements reside within a virtual environment representative of the source location; and processing circuitry communicatively coupled to the memory, and configured to: determine that a listener has moved between the two or more audio elements; rescale, responsive to determining that the listener has moved between the two or more audio elements and based on the respective regions, the two or more audio elements to obtain at least one rescaled audio element; and reproduce the at least one rescaled audio element to obtain an output audio signal.

In another one example, the techniques are directed to a method of scaling audio between a source location and a playback location, the method comprising: storing, by processing circuitry, metadata specified for two or more audio elements, the metadata identifying a respective region in which each of the two or more audio elements reside within a virtual environment representative of the source location; and determining, by the processing circuitry, that a listener has moved between the two or more audio elements; rescaling, by the processing circuitry, responsive to determining that the listener has moved between the two or more audio elements, and based on the respective regions, the two or more audio elements to obtain at least one rescaled audio element; and reproducing, by the processing circuitry, the at least one rescaled audio element to obtain an output audio signal.

In another one example, the techniques are directed to a non-transitory computer-readable storage medium having stored thereon instructions that, when executed, cause processing circuitry to: store metadata specified for two or more audio elements, the metadata identifying a respective region in which each of the two or more audio elements reside within a virtual environment representative of the source location; and determine that a listener has moved between the two or more audio elements; rescale, responsive to determining that the listener has moved between the two or more audio elements and based on the respective regions, the two or more audio elements to obtain at least one resealed audio element; and reproduce the at least one rescaled audio element to obtain an output audio signal.

In another one example, the techniques are directed to a device configured to encode an audio bitstream, the device comprising: a memory configured to store two or more audio elements, and processing circuitry coupled to the memory, and configured to: encode the two or more audio elements to obtain an audio bitstream; specify, in the audio bitstream, a syntax element indicating how rescaling is to be performed when a listener moves between the two or more audio elements; and output the audio bitstream.

In another one example, the techniques are directed to a method for encoding an audio bitstream, the method comprising: encoding two or more audio elements to obtain an audio bitstream; specifying, in the audio bitstream, a syntax element indicating how rescaling is to be performed when a listener moves between the two or more audio elements; and outputting the audio bitstream.

In another one example, the techniques are directed to a non-transitory computer-readable storage medium having stored thereon instructions that, when executed cause processing circuitry to: encode two or more audio elements to obtain an audio bitstream; specify, in the audio bitstream, a syntax element indicating how rescaling is to be performed when a listener moves between the two or more audio elements; and output the audio bitstream.

In another one example, the techniques are directed to a device configured to scale audio between a source location and a playback location, the device comprising: a memory configured to store an audio element residing within a virtual environment representative of the source location; and processing circuitry communicatively coupled to the memory, and configured to: determine that a listener has either or both of moved between virtual rooms within the virtual environment and moved between physical rooms within the playback location; rescale, responsive to determining that the listener has either or both of moved between the virtual rooms within the virtual environment and moved between the physical rooms within the playback location, the audio element to obtain a rescaled audio element; and reproduce the rescaled audio element to obtain an output audio signal.

In another one example, the techniques are directed to a method for scaling audio between a source location and a playback location, the method comprising: storing an audio element residing within a virtual environment representative of the source location; determining that a listener has either or both of moved between virtual rooms within the virtual environment and moved between physical rooms within the playback location; rescaling, responsive to determining that the listener has either or both of moved between the virtual rooms within the virtual environment and moved between the physical rooms within the playback location, the audio element to obtain a rescaled audio element; and reproducing the rescaled audio element to obtain an output audio signal.

In another one example, the techniques are directed to a non-transitory computer-readable storage medium having stored thereon instructions that, when executed, cause processing circuitry to: store an audio element residing within a virtual environment representative of the source location; determine that a listener has either or both of moved between virtual rooms within the virtual environment and moved between physical rooms within the playback location; rescale, responsive to determining that the listener has either or both of moved between the virtual rooms within the virtual environment and moved between the physical rooms within the playback location, the audio element to obtain a rescaled audio element; and reproduce the rescaled audio element to obtain an output audio signal.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIGS. 1A and 1B are diagrams illustrating systems that may perform various aspects of the techniques described in this disclosure.

FIG. 2 is a block diagram illustrating example physical spaces in which various aspects of the rescaling techniques are performed in order to facilitate increased immersion while consuming extended reality scenes.

FIGS. 3A and 3B are block diagrams illustrating further example physical spaces in which various aspects of the rescaling techniques are performed in order to facilitate increased immersion while consuming extended reality scenes.

FIGS. 4A and 4B are flowcharts illustrating exemplary operation of an extended reality system shown in the example of FIG. 1 in performing various aspects of the rescaling techniques described in this disclosure.

FIGS. 5A and 5B are diagrams illustrating examples of XR devices.

FIG. 6 illustrates an example of a wireless communications system that supports audio streaming in accordance with aspects of the present disclosure.

FIGS. 7A-7C are diagrams illustrating example operation of the extended reality system shown in the example of FIGS. 1A and 1B in performing various aspects of the tolerance modified rescale techniques.

FIGS. 8A-8C are additional diagrams illustrating example operation of the extended reality system shown in the example of FIGS. 1A and 1B in performing various aspects of the tolerance modified rescale techniques.

FIGS. 9A and 9B are further diagrams illustrating example operation of the extended reality system shown in the example of FIGS. 1A and 1B in performing various aspects of the tolerance modified rescale techniques.

FIG. 10 is yet another diagram illustrating example operation of the extended reality system shown in the example of FIGS. 1A and 1B in performing various aspects of the tolerance modified rescale techniques.

FIGS. 11A-11C are diagrams illustrating syntax tables for enabling various aspects of the tolerance modified rescale techniques.

FIG. 12 is a block diagram illustrating example physical spaces in which various aspects of the offset-based rescaling techniques are performed in order to facilitate increased immersion while consuming extended reality scenes.

FIG. 13 is a block diagram illustrating an example audio scene in which offset-based rescaling may be performed according to various aspects of the techniques.

FIG. 14 is a block diagram illustrating the renderer initializer of FIG. 1 in more detail that is configured to implement the offset-based scaling techniques in more detail.

FIG. 15 illustrates a flowchart providing example operation of the renderer initializer shown throughout the examples of FIGS. 1A-14 in performing various aspect of the offset-based scaling techniques described in this disclosure.

FIG. 16 is a block diagram of an illustrative aspect of components of a device operable to perform offset scaling for spacing-based audio source group processing, in accordance with some examples of the present disclosure.

FIG. 17 is a flowchart illustrating example operation of the scene manager of FIGS. 1A and 1B in performing various aspects of the dynamic rescale techniques described in this disclosure.

FIGS. 18A and 18B are diagrams illustrating an example of auto rescale responsive to listener movement between audio elements in accordance with various aspects of the dynamic rescale techniques.

FIG. 19 is a diagram illustrating an example of the auto rescale when the listener moves between physical rooms in accordance with various aspects of the dynamic rescale techniques described in this disclosure.

FIG. 20 is a diagram illustrating an example of auto rescale performed when the listener moves between virtual rooms in accordance with various aspects of the dynamic rescale techniques described in this disclosure.

FIG. 21 is a flowchart illustrating example operation of the playback system shown in FIG. 1 in performing various aspects of the audio source rescaling techniques.

FIG. 22 is a flowchart illustrating example operation of the soundfield representation generator shown in FIG. 1 in performing various aspects of the audio source rescaling techniques.

FIG. 23 is a flowchart illustrating another example operation of the playback system shown in FIG. 1 in performing various aspects of the audio source rescaling techniques.

### DETAILED DESCRIPTION

There are a number of different ways to represent a soundfield. Example formats include channel-based audio formats, object-based audio formats, and scene-based audio formats. Channel-based audio formats refer to the 5.1 surround sound format, 7.1 surround sound formats, 22.2 surround sound formats, or any other channel-based format that localizes audio channels to particular locations around the listener in order to recreate a soundfield.

Object-based audio formats may refer to formats in which audio objects, often encoded using pulse-code modulation (PCM) and referred to as PCM audio objects, are specified in order to represent the soundfield. Such audio objects may include metadata identifying a location of the audio object relative to a listener or other point of reference in the soundfield, such that the audio object may be rendered to one or more speaker channels for playback in an effort to recreate the soundfield. The techniques described in this disclosure may apply to any of the foregoing formats, including scene-based audio formats, channel-based audio formats, object-based audio formats, or any combination thereof.

Scene-based audio formats may include a hierarchical set of elements that define the soundfield in three dimensions. One example of a hierarchical set of elements is a set of spherical harmonic coefficients (SHC). The following expression demonstrates a description or representation of a soundfield using SHC:

$${p}_{i} ( t , {r}_{r} , {θ}_{r} , {φ}_{r} ) = {\sum }_{ω = 0}^{∞} [ 4 π {\sum }_{n = 0}^{∞} {j}_{n} ( k {r}_{r} ) {\sum }_{m = - n}^{n} {A}_{n}^{m} ( k ) {Y}_{n}^{m} ( {θ}_{r} , {φ}_{r} ) ] {e}^{j ω t} ,$$

The expression shows that the pressure pᵢ at any point {rᵣ, θᵣ, φᵣ} of the soundfield, at time t, can be represented uniquely by the SHC,

$${A}_{n}^{m} ( k ) .$$

### Here,

$$k = \frac{ω}{c} ,$$

c is the speed of sound (˜343 m/s), {rᵣ, θᵣ, φᵣ} is a point of reference (or observation point), jₙ(⋅) is the spherical Bessel function of order n, and

$${Y}_{n}^{m} ( {θ}_{r} , {φ}_{r} )$$

are the spherical harmonic basis functions (which may also be referred to as a spherical basis function) of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

The SHC

$${A}_{n}^{m} ( k )$$

can either be physically acquired (e.g., recorded) by various microphone array configurations or, alternatively, they can be derived from channel-based or object-based descriptions of the soundfield. The SHC (which also may be referred to as ambisonic coefficients) represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be physically acquired from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

The following equation may illustrate how the SHCs may be derived from an object-based description. The coefficients

$${A}_{n}^{m} ( k )$$

for the soundfield corresponding to an individual audio object may be expressed as:

$${A}_{n}^{m} ( k ) = g ( ω ) ( - 4 π i k ) {h}_{n}^{( 2 )} ( {kr}_{s} ) {Y}_{n}^{{m}^{*}} ( {θ}_{s} , {φ}_{s} ) ,$$

where i is \sqrt{−1},

$${h}_{n}^{( 2 )} ( \cdot )$$

is the spherical Hankel function (of the second kind) of order n, and {rₛ, θᵣ, φₛ} is the location of the object. Knowing the object source energy g(ω) as a function of frequency (e.g., using time-frequency analysis techniques, such as performing a fast Fourier transform on the pulse code modulated—PCM—stream) may enable conversion of each PCM object and the corresponding location into the SHC

$${A}_{n}^{m} ( k ) .$$

Further, it can be shown (since the above is a linear and orthogonal decomposition) that the

$${A}_{n}^{m} ( k )$$

coefficients for each object are additive. In this manner, a number of PCM objects can be represented by the

$${A}_{n}^{m} ( k )$$

coefficients (e.g., as a sum of the coefficient vectors for the individual objects). The coefficients may contain information about the soundfield (the pressure as a function of 3D coordinates), and the above represents the transformation from individual objects to a representation of the overall soundfield, in the vicinity of the observation point {rᵣ, θᵣ, φᵣ}.

Computer-mediated reality systems (which may also be referred to as “extended reality systems,” or “XR systems”) are being developed to take advantage of many of the potential benefits provided by ambisonic coefficients. For example, ambisonic coefficients may represent a soundfield in three dimensions in a manner that potentially enables accurate three-dimensional (3D) localization of sound sources within the soundfield. As such, XR devices may render the ambisonic coefficients to speaker feeds that, when played via one or more speakers, accurately reproduce the soundfield.

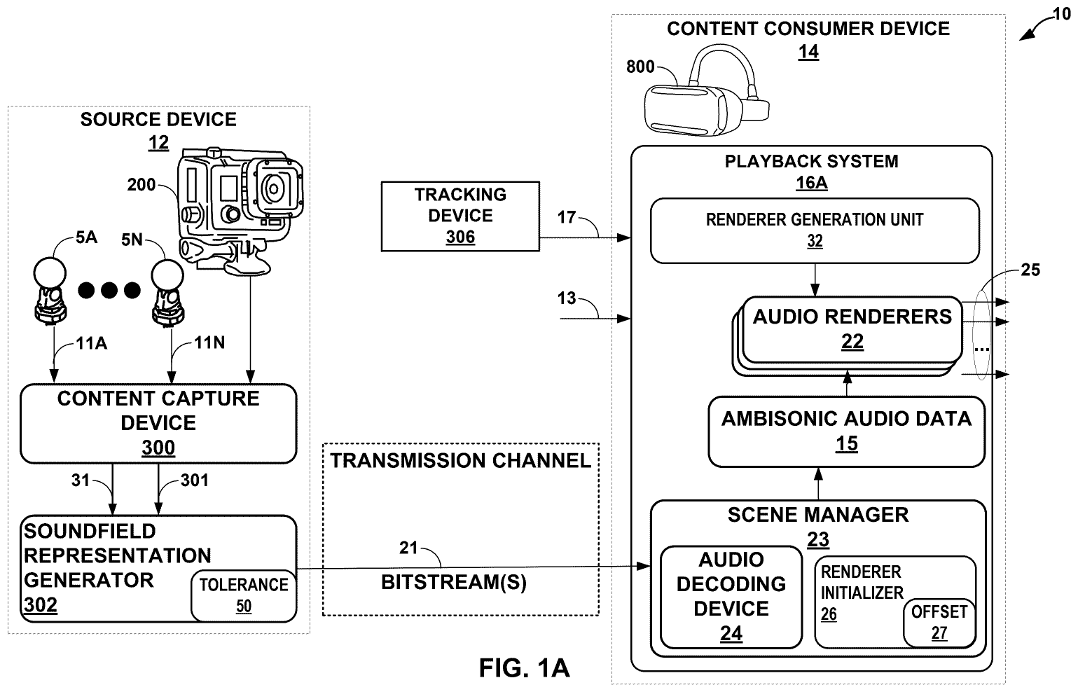

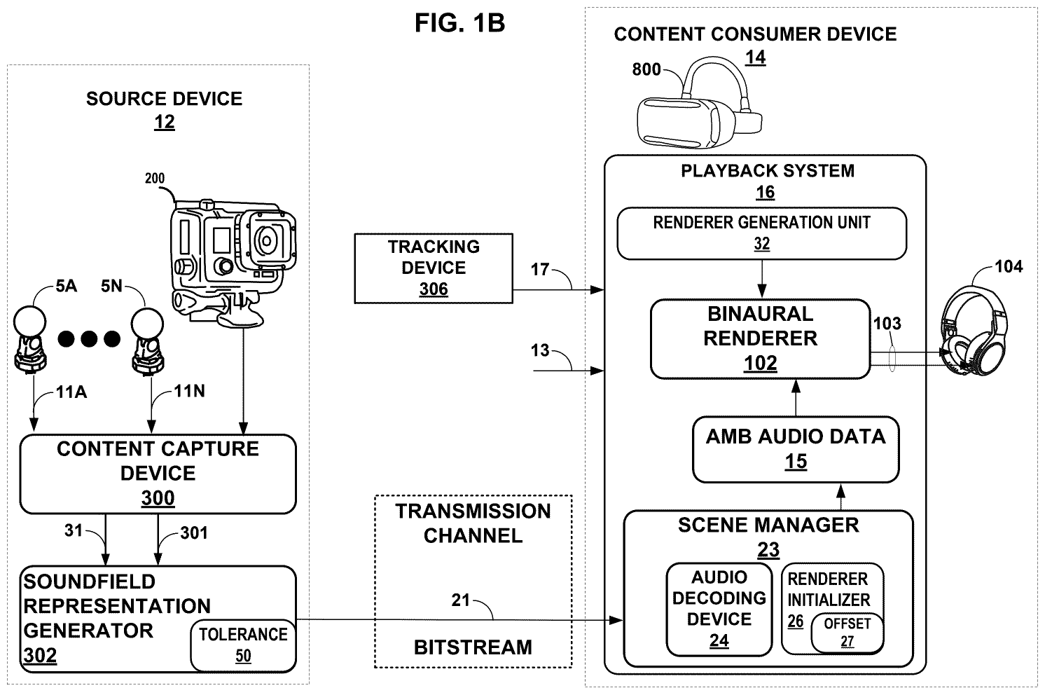

The use of ambisonic coefficients for XR may enable development of a number of use cases that rely on the more immersive soundfields provided by the ambisonic coefficients, particularly for computer gaming applications and live visual streaming applications. In these highly dynamic use cases that rely on low latency reproduction of the soundfield, the XR devices may prefer ambisonic coefficients over other representations that are more difficult to manipulate or involve complex rendering. More information regarding these use cases is provided below with respect to FIGS. 1A and 1B.

While described in this disclosure with respect to the VR device, various aspects of the techniques may be performed in the context of other devices, such as a mobile device. In this instance, the mobile device (such as a so-called smartphone) may present the displayed world via a screen, which may be mounted to the head of the user 402 or viewed as would be done when normally using the mobile device. As such, any information on the screen can be part of the mobile device. The mobile device may be able to provide tracking information and thereby allow for both a VR experience (when head mounted) and a normal experience to view the displayed world, where the normal experience may still allow the user to view the displayed world proving a VR-lite-type experience (e.g., holding up the device and rotating or translating the device to view different portions of the displayed world).

This disclosure may provide for scaling audio sources in extended reality systems. Rather than require users to only operate extended reality systems in locations that permit one-to-one correspondence in terms of spacing with a source location (or in other words space) at which the extended reality scene was captured and/or for which the extended reality scene was generated, various aspects of the techniques enable an extended reality system to scale a source location to accommodate a playback location. As such, if the source location includes microphones that are spaced 10 meters (10 M) apart, the extended reality system may scale that spacing resolution of 10 M to accommodate a scale of a playback location using a scaling factor that is determined based on a source dimension defining a size of the source location and a playback dimension defining a size of a playback location. Using the scaling provided in accordance with various aspects of the techniques described in this disclosure, the extended reality system may improve reproduction of the soundfield to modify a location of audio sources to accommodate the size of the playback space.

FIGS. 1A and 1B are diagrams illustrating systems that may perform various aspects of the techniques described in this disclosure. As shown in the example of FIG. 1A, system 10 includes a source device 12 and a content consumer device 14. While described in the context of the source device 12 and the content consumer device 14, the techniques may be implemented in any context in which any hierarchical representation of a soundfield is encoded to form a bitstream representative of the audio data. Moreover, the source device 12 may represent any form of computing device capable of generating hierarchical representation of a soundfield, and is generally described herein in the context of being a VR content creator device. Likewise, the content consumer device 14 may represent any form of computing device capable of implementing the audio stream interpolation techniques described in this disclosure as well as audio playback, and is generally described herein in the context of being a VR client device.

The source device 12 may be operated by an entertainment company or other entity that may generate multi-channel audio content for consumption by operators of content consumer devices, such as the content consumer device 14. In many VR scenarios, the source device 12 generates audio content in conjunction with visual content. The source device 12 includes a content capture device 300 and a content soundfield representation generator 302.

The content capture device 300 may be configured to interface or otherwise communicate with one or more microphones 5A-5N (“microphones 5”). The microphones 5 may represent an Eigenmike® or other type of 3D audio microphone capable of capturing and representing the soundfield as corresponding scene-based audio data 11A-11N (which may also be referred to as ambisonic coefficients 11A-11N or “ambisonic coefficients 11”). In the context of scene-based audio data 11 (which is another way to refer to the ambisonic coefficients 11”), each of the microphones 5 may represent a cluster of microphones arranged within a single housing according to set geometries that facilitate generation of the ambisonic coefficients 11. As such, the term microphone may refer to a cluster of microphones (which are actually geometrically arranged transducers) or a single microphone (which may be referred to as a spot microphone or spot transducer).

The ambisonic coefficients 11 may represent one example of an audio stream. As such, the ambisonic coefficients 11 may also be referred to as audio streams 11. Although described primarily with respect to the ambisonic coefficients 11, the techniques may be performed with respect to other types of audio streams, including pulse code modulated (PCM) audio streams, channel-based audio streams, object-based audio streams, etc.

The content capture device 300 may, in some examples, include an integrated microphone that is integrated into the housing of the content capture device 300. The content capture device 300 may interface wirelessly or via a wired connection with the microphones 5. Rather than capture, or in conjunction with capturing, audio data via the microphones 5, the content capture device 300 may process the ambisonic coefficients 11 after the ambisonic coefficients 11 are input via some type of removable storage, wirelessly, and/or via wired input processes, or alternatively or in conjunction with the foregoing, generated or otherwise created (from stored sound samples, such as is common in gaming applications, etc.). As such, various combinations of the content capture device 300 and the microphones 5 are possible.

The content capture device 300 may also be configured to interface or otherwise communicate with the soundfield representation generator 302. The soundfield representation generator 302 may include any type of hardware device capable of interfacing with the content capture device 300. The soundfield representation generator 302 may use the ambisonic coefficients 11 provided by the content capture device 300 to generate various representations of the same soundfield represented by the ambisonic coefficients 11.

For instance, to generate the different representations of the soundfield using ambisonic coefficients (which again is one example of the audio streams), the soundfield representation generator 302 may use a coding scheme for ambisonic representations of a soundfield, referred to as Mixed Order Ambisonics (MOA) as discussed in more detail in U.S. application Ser. No. 15/672,058, entitled “MIXED-ORDER AMBISONICS (MOA) AUDIO DATA FO COMPUTER-MEDIATED REALITY SYSTEMS,” filed Aug. 8, 2017, and published as U.S. patent publication no. 20190007781 on Jan. 3, 2019.

To generate a particular MOA representation of the soundfield, the soundfield representation generator 302 may generate a partial subset of the full set of ambisonic coefficients (where the term “subset” is used not in the strict mathematical sense to include zero or more, if not all, of the full set, but instead may refer to one or more, but not all of the full set). For instance, each MOA representation generated by the soundfield representation generator 302 may provide precision with respect to some areas of the soundfield, but less precision in other areas. In one example, an MOA representation of the soundfield may include eight (8) uncompressed ambisonic coefficients, while the third order ambisonic representation of the same soundfield may include sixteen (16) uncompressed ambisonic coefficients. As such, each MOA representation of the soundfield that is generated as a partial subset of the ambisonic coefficients may be less storage-intensive and less bandwidth intensive (if and when transmitted as part of the bitstream 27 over the illustrated transmission channel) than the corresponding third order ambisonic representation of the same soundfield generated from the ambisonic coefficients.

Although described with respect to MOA representations, the techniques of this disclosure may also be performed with respect to first-order ambisonic (FOA) representations in which all of the ambisonic coefficients associated with a first order spherical basis function and a zero order spherical basis function are used to represent the soundfield. In other words, rather than represent the soundfield using a partial, non-zero subset of the ambisonic coefficients, the soundfield representation generator 302 may represent the soundfield using all of the ambisonic coefficients for a given order N, resulting in a total of ambisonic coefficients equaling (N+1)².

In this respect, the ambisonic audio data (which is another way to refer to the ambisonic coefficients in either MOA representations or full order representations, such as the first-order representation noted above) may include ambisonic coefficients associated with spherical basis functions having an order of one or less (which may be referred to as “1^{st} order ambisonic audio data”), ambisonic coefficients associated with spherical basis functions having a mixed order and suborder (which may be referred to as the “MOA representation” discussed above), or ambisonic coefficients associated with spherical basis functions having an order greater than one (which is referred to above as the “full order representation”).

The content capture device 300 may, in some examples, be configured to wirelessly communicate with the soundfield representation generator 302. In some examples, the content capture device 300 may communicate, via one or both of a wireless connection or a wired connection, with the soundfield representation generator 302. Via the connection between the content capture device 300 and the soundfield representation generator 302, the content capture device 300 may provide content in various forms of content, which, for purposes of discussion, are described herein as being portions of the ambisonic coefficients 11.

In some examples, the content capture device 300 may leverage various aspects of the soundfield representation generator 302 (in terms of hardware or software capabilities of the soundfield representation generator 302). For example, the soundfield representation generator 302 may include dedicated hardware configured to (or specialized software that when executed causes one or more processors to) perform psychoacoustic audio encoding (such as a unified speech and audio coder denoted as “USAC” set forth by the Moving Picture Experts Group (MPEG), the MPEG-H 3D audio coding standard, the MPEG-I Immersive Audio standard, or proprietary standards, such as AptX™ (including various versions of AptX such as enhanced AptX—E-AptX, AptX live, AptX stereo, and AptX high definition—AptX-HD), advanced audio coding (AAC), Audio Codec 3 (AC-3), Apple Lossless Audio Codec (ALAC), MPEG-4 Audio Lossless Streaming (ALS), enhanced AC-3, Free Lossless Audio Codec (FLAC), Monkey's Audio, MPEG-1 Audio Layer II (MP2), MPEG-1 Audio Layer III (MP3), Opus, and Windows Media Audio (WMA).

The content capture device 300 may not include the psychoacoustic audio encoder dedicated hardware or specialized software and instead provide audio aspects of the content 301 in a non-psychoacoustic audio coded form. The soundfield representation generator 302 may assist in the capture of content 301 by, at least in part, performing psychoacoustic audio encoding with respect to the audio aspects of the content 301.

The soundfield representation generator 302 may also assist in content capture and transmission by generating one or more bitstreams 21 based, at least in part, on the audio content (e.g., MOA representations, third order ambisonic representations, and/or first order ambisonic representations) generated from the ambisonic coefficients 11. The bitstream 21 may represent a compressed version of the ambisonic coefficients 11 (and/or the partial subsets thereof used to form MOA representations of the soundfield) and any other different types of the content 301 (such as a compressed version of spherical visual data, image data, or text data).

The soundfield representation generator 302 may generate the bitstream 21 for transmission, as one example, across a transmission channel, which may be a wired or wireless channel, a data storage device, or the like. The bitstream 21 may represent an encoded version of the ambisonic coefficients 11 (and/or the partial subsets thereof used to form MOA representations of the soundfield) and may include a primary bitstream and another side bitstream, which may be referred to as side channel information. In some instances, the bitstream 21 representing the compressed version of the ambisonic coefficients 11 may conform to bitstreams produced in accordance with the MPEG-H 3D audio coding standard and/or an MPEG-I standard for “Coded Representations of Immersive Media.”

The content consumer device 14 may be operated by an individual, and may represent a VR client device. Although described with respect to a VR client device, content consumer device 14 may represent other types of devices, such as an augmented reality (AR) client device, a mixed reality (MR) client device (or any other type of head-mounted display device or extended reality—XR—device), a standard computer, a headset, headphones, or any other device capable of tracking head movements and/or general translational movements of the individual operating the content consumer device 14. As shown in the example of FIG. 1A, the content consumer device 14 includes an audio playback system 16A, which may refer to any form of audio playback system capable of rendering ambisonic coefficients (whether in form of first order, second order, and/or third order ambisonic representations and/or MOA representations) for playback as multi-channel audio content.

The content consumer device 14 may retrieve the bitstream 21 directly from the source device 12. In some examples, the content consumer device 14 may interface with a network, including a fifth generation (5G) cellular network, to retrieve the bitstream 21 or otherwise cause the source device 12 to transmit the bitstream 21 to the content consumer device 14.

While shown in FIG. 1A as being directly transmitted to the content consumer device 14, the source device 12 may output the bitstream 21 to an intermediate device positioned between the source device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding visual data bitstream) to subscribers, such as the content consumer device 14, requesting the bitstream 21.

Alternatively, the source device 12 may store the bitstream 21 to a storage medium, such as a compact disc, a digital visual disc, a high definition visual disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 1A.

As noted above, the content consumer device 14 includes the audio playback system 16. The audio playback system 16 may represent any system capable of playing back multi-channel audio data. The audio playback system 16A may include a number of different audio renderers 22. The renderers 22 may each provide for a different form of audio rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16A may further include an audio decoding device 24. The audio decoding device 24 may represent a device configured to decode bitstream 21 to output reconstructed ambisonic coefficients 11A′-11N′ (which may form the full first, second, and/or third order ambisonic representation or a subset thereof that forms an MOA representation of the same soundfield or decompositions thereof, such as the predominant audio signal, ambient ambisonic coefficients, and the vector based signal described in the MPEG-H 3D Audio Coding Standard and/or the MPEG-I Immersive Audio standard).

As such, the ambisonic coefficients 11A′-11N′ (“ambisonic coefficients 11′”) may be similar to a full set or a partial subset of the ambisonic coefficients 11, but may differ due to lossy operations (e.g., quantization) and/or transmission via the transmission channel. The audio playback system 16 may, after decoding the bitstream 21 to obtain the ambisonic coefficients 11′, obtain ambisonic audio elements 15 from the different streams of ambisonic coefficients 11′, and render the ambisonic audio elements 15 to output speaker feeds 25. The speaker feeds 25 may drive one or more speakers (which are not shown in the example of FIG. 1A for ease of illustration purposes). Ambisonic representations of a soundfield may be normalized in a number of ways, including N3D, SN3D, FuMa, N2D, or SN2D.

To select the appropriate renderer or, in some instances, generate an appropriate renderer, the audio playback system 16A may obtain loudspeaker information 13 indicative of a number of loudspeakers and/or a spatial geometry of the loudspeakers. In some instances, the audio playback system 16A may obtain the loudspeaker information 13 using a reference microphone and outputting a signal to activate (or, in other words, drive) the loudspeakers in such a manner as to dynamically determine, via the reference microphone, the loudspeaker information 13. In other instances, or in conjunction with the dynamic determination of the loudspeaker information 13, the audio playback system 16A may prompt a user to interface with the audio playback system 16A and input the loudspeaker information 13.

The audio playback system 16A may select one of the audio renderers 22 based on the loudspeaker information 13. In some instances, the audio playback system 16A may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16A may, in some instances, generate one of the audio renderers 22 based on the loudspeaker information 13 without first attempting to select an existing one of the audio renderers 22.

When outputting the speaker feeds 25 to headphones, the audio playback system 16A may utilize one of the renderers 22 that provides for binaural rendering using head-related transfer functions (HRTF) or other functions capable of rendering to left and right speaker feeds 25 for headphone speaker playback. The terms “speakers” or “transducer” may generally refer to any speaker, including loudspeakers, headphone speakers, etc. One or more speakers may then playback the rendered speaker feeds 25.

Although described as rendering the speaker feeds 25 from the ambisonic audio elements 15, reference to rendering of the speaker feeds 25 may refer to other types of rendering, such as rendering incorporated directly into the decoding of the ambisonic audio elements 15 from the bitstream 21. An example of the alternative rendering can be found in Annex G of the MPEG-H 3D audio coding standard, where rendering occurs during the predominant signal formulation and the background signal formation prior to composition of the soundfield. As such, reference to rendering of the ambisonic audio elements 15 should be understood to refer to both rendering of the actual ambisonic audio elements 15 or decompositions or representations thereof of the ambisonic audio elements 15 (such as the above noted predominant audio signal, the ambient ambisonic coefficients, and/or the vector-based signal—which may also be referred to as a V-vector).

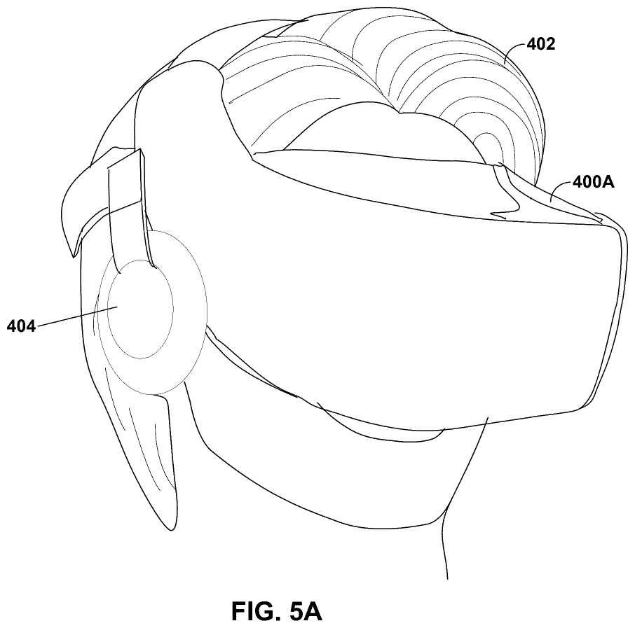

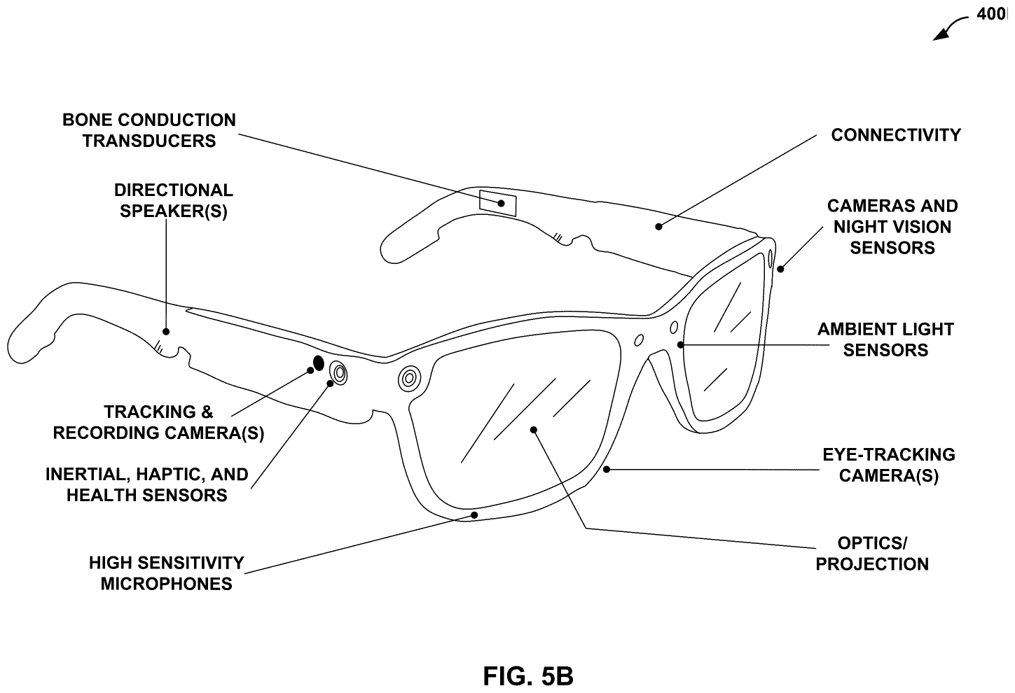

As described above, the content consumer device 14 may represent a VR device in which a human wearable display is mounted in front of the eyes of the user operating the VR device. FIGS. 5A and 5B are diagrams illustrating examples of VR devices 400A and 400B. In the example of FIG. 5A, the VR device 400A is coupled to, or otherwise includes headphones 404, which may reproduce a soundfield represented by the ambisonic audio elements 15 (which is another way to refer to ambisonic coefficients) through playback of the speaker feeds 25. The speaker feeds 25 may represent an analog or digital signal capable of causing a membrane within the transducers of headphones 404 to vibrate at various frequencies. Such a process is commonly referred to as driving the headphones 404.

Visual, audio, and other sensory data may play important roles in the VR experience. To participate in a VR experience, a user 402 may wear the VR device 400A (which may also be referred to as a VR headset 400A) or other wearable electronic device. The VR client device (such as the VR headset 400A) may track head movement of the user 402, and adapt the visual data shown via the VR device 400A to account for the head movements, providing an immersive experience in which the user 402 may experience a virtual world shown in the visual data in visual three dimensions.

While VR (and other forms of AR and/or MR, which may generally be referred to as a computer mediated reality device) may allow the user 402 to reside in the virtual world visually, often the VR headset 400A may lack the capability to place the user in the virtual world audibly. In other words, the VR system (which may include a computer responsible for rendering the visual data and audio data—that is not shown in the example of FIG. 5A for ease of illustration purposes, and the VR headset 400A) may be unable to support full three dimension immersion audibly.

FIG. 5B is a diagram illustrating an example of a wearable device 400B that may operate in accordance with various aspect of the techniques described in this disclosure. In various examples, the wearable device 400B may represent a VR headset (such as the VR headset 400A described above), an AR headset, an MR headset, or any other type of XR headset. Augmented Reality “AR” may refer to computer rendered image or data that is overlaid over the real world where the user is actually located. Mixed Reality “MR” may refer to computer rendered image or data that is world locked to a particular location in the real world, or may refer to a variant on VR in which part computer rendered 3D elements and part photographed real elements are combined into an immersive experience that simulates the user's physical presence in the environment. Extended Reality “XR” may represent a catchall term for VR, AR, and MR. More information regarding terminology for XR can be found in a document by Jason Peterson, entitled “Virtual Reality, Augmented Reality, and Mixed Reality Definitions,” and dated Jul. 7, 2017.

The wearable device 400B may represent other types of devices, such as a watch (including so-called “smart watches”), glasses (including so-called “smart glasses”), headphones (including so-called “wireless headphones” and “smart headphones”), smart clothing, smart jewelry, and the like. Whether representative of a VR device, a watch, glasses, and/or headphones, the wearable device 400B may communicate with the computing device supporting the wearable device 400B via a wired connection or a wireless connection.

In some instances, the computing device supporting the wearable device 400B may be integrated within the wearable device 400B and as such, the wearable device 400B may be considered as the same device as the computing device supporting the wearable device 400B. In other instances, the wearable device 400B may communicate with a separate computing device that may support the wearable device 400B. In this respect, the term “supporting” should not be understood to require a separate dedicated device but that one or more processors configured to perform various aspects of the techniques described in this disclosure may be integrated within the wearable device 400B or integrated within a computing device separate from the wearable device 400B.

For example, when the wearable device 400B represents an example of the VR device 400B, a separate dedicated computing device (such as a personal computer including the one or more processors) may render the audio and visual content, while the wearable device 400B may determine the translational head movement upon which the dedicated computing device may render, based on the translational head movement, the audio content (as the speaker feeds) in accordance with various aspects of the techniques described in this disclosure. As another example, when the wearable device 400B represents smart glasses, the wearable device 400B may include the one or more processors that both determine the translational head movement (by interfacing within one or more sensors of the wearable device 400B) and render, based on the determined translational head movement, the speaker feeds.

As shown, the wearable device 400B includes one or more directional speakers, and one or more tracking and/or recording cameras. In addition, the wearable device 400B includes one or more inertial, haptic, and/or health sensors, one or more eye-tracking cameras, one or more high sensitivity audio microphones, and optics/projection hardware. The optics/projection hardware of the wearable device 400B may include durable semi-transparent display technology and hardware.

The wearable device 400B also includes connectivity hardware, which may represent one or more network interfaces that support multimode connectivity, such as 4G communications, 5G communications, Bluetooth, etc. The wearable device 400B also includes one or more ambient light sensors, and bone conduction transducers. In some instances, the wearable device 400B may also include one or more passive and/or active cameras with fisheye lenses and/or telephoto lenses. Although not shown in FIG. 5B, the wearable device 400B also may include one or more light emitting diode (LED) lights. In some examples, the LED light(s) may be referred to as “ultra bright” LED light(s). The wearable device 400B also may include one or more rear cameras in some implementations. It will be appreciated that the wearable device 400B may exhibit a variety of different form factors.

Furthermore, the tracking and recording cameras and other sensors may facilitate the determination of translational distance. Although not shown in the example of FIG. 5B, wearable device 400B may include other types of sensors for detecting translational distance.

Although described with respect to particular examples of wearable devices, such as the VR device 400B discussed above with respect to the examples of FIG. 5B and other devices set forth in the examples of FIGS. 1A and 1B, a person of ordinary skill in the art would appreciate that descriptions related to FIGS. 1A-5B may apply to other examples of wearable devices. For example, other wearable devices, such as smart glasses, may include sensors by which to obtain translational head movements. As another example, other wearable devices, such as a smart watch, may include sensors by which to obtain translational movements. As such, the techniques described in this disclosure should not be limited to a particular type of wearable device, but any wearable device may be configured to perform the techniques described in this disclosure.

In the example of FIG. 1A, the source device 12 further includes a camera 200. The camera 200 may be configured to capture visual data, and provide the captured raw visual data to the content capture device 300. The content capture device 300 may provide the visual data to another component of the source device 12, for further processing into viewport-divided portions.

The content consumer device 14 also includes the wearable device 800. It will be understood that, in various implementations, the wearable device 800 may be included in, or externally coupled to, the content consumer device 14. As discussed above with respect to FIGS. 5A and 5B, the wearable device 800 includes display hardware and speaker hardware for outputting visual data (e.g., as associated with various viewports) and for rendering audio data.

In any event, the audio aspects of VR have been classified into three separate categories of immersion. The first category provides the lowest level of immersion, and is referred to as three degrees of freedom (3DOF). 3DOF refers to audio rendering that accounts for movement of the head in the three degrees of freedom (yaw, pitch, and roll), thereby allowing the user to freely look around in any direction. 3DOF, however, cannot account for translational head movements in which the head is not centered on the optical and acoustical center of the soundfield.

The second category, referred to 3DOF plus (3DOF+), provides for the three degrees of freedom (yaw, pitch, and roll) in addition to limited spatial translational movements due to the head movements away from the optical center and acoustical center within the soundfield. 3DOF+ may provide support for perceptual effects such as motion parallax, which may strengthen the sense of immersion.

The third category, referred to as six degrees of freedom (6DOF), renders audio data in a manner that accounts for the three degrees of freedom in term of head movements (yaw, pitch, and roll) but also accounts for translation of the user in space (x, y, and z translations). The spatial translations may be induced by sensors tracking the location of the user in the physical world or by way of an input controller.

[0095]3DOF rendering is the current state of the art for audio aspects of VR. As such, the audio aspects of VR are less immersive than the visual aspects, thereby potentially reducing the overall immersion experienced by the user, and introducing localization errors (e.g., such as when the auditory playback does not match or correlate exactly to the visual scene).

Although 3DOF rendering is the current state, more immersive audio rendering, such as 3DOF+ and 6DOF rendering, may result in higher complexity in terms of processor cycles expended, memory and bandwidth consumed, etc. Furthermore, rendering for 6DOF may require additional granularity in terms of pose (which may refer to position and/or orientation) that results in the higher complexity, while also complicating certain XR scenarios in terms of asynchronous capture of audio data and visual data.

For example, consider XR scenes that involve live audio data capture (e.g., XR conferences, visual conferences, visual chat, metaverses, XR games, live action events —such as concerts, sports games, symposiums, conferences, and the like, etc.) in which avatars (an example visual object) speak to one another using microphones to capture the live audio and convert such live audio into audio objects (which may also be referred to as audio elements as the audio objects are not necessarily defined in the object format).

In some instances, capture of an XR scene may occur in large physical spaces, such as concert venues, stadiums (e.g., for sports, concerts, symposiums, etc.), conference halls (e.g., for symposiums), etc. that may be larger than a normal playback space, such as a living room, recreation room, television room, bedroom, and the like. That is, a person experiencing an XR scene may not have a physical space that is on the same scale as the capture location.

In VR scenes, a user may teleport to different locations within the capture environment. With the ability to overlay digital content on real world, or in other words physical, spaces (which occurs, for example, in AR), the inability to teleport to different locations (which may refer to virtual locations or, in other words, locations in the XR scene) may result in issues that restrict how the playback space may recreate an immersive experience for such XR scenes. That is, the audio experience may suffer due to scale differences between a content capture space and the playback space, which may prevent users from fully participating in the XR scenes.

In some instances, the audio playback system 16 may scale audio sources in extended reality system 10. Rather than require users to only operate extended reality system 10 in locations that permit one-to-one correspondence in terms of spacing with a source location at which the extended reality scene was captured and/or for which the extended reality scene was generated, extended reality system 10 may scale a source location to accommodate a playback location. As such, if the source location includes microphones that are spaced 10 meters (10 M) apart, extended reality system 10 may scale that spacing resolution of 10 M to accommodate a scale of a playback location using a scaling factor (which may also be referred to as a rescaling factor) that is determined based on a source dimension defining a size of the source location and a playback dimension defining a size of a playback location.

In operation, the soundfield representation generator 302 may specify, in the audio bitstream 21, a syntax element indicative of a rescaling factor for the audio element. The rescaling factor may indicate how a location of the audio element is to be rescaled relative to other audio elements. The soundfield representation generator 302 may also specify a syntax element indicating that auto rescale is to be performed for a duration in which the audio element is present for playback. The soundfield representation generator 302 may then output the audio bitstream 21.

The audio playback system 16A may receive the audio bitstream 21 and extract syntax elements indicative of one or more source dimensions associated with a source space for the XR scene. In some instances, the syntax elements may be specified in a side channel of metadata or other extensions to the audio bitstream 21. Regardless, the audio playback system 16A may parse the source dimensions (e.g., as syntax elements) from the audio bitstream 21 or otherwise obtain the source dimensions associated with the source space for the XR scene.

The audio playback system 16A may also obtain a playback dimension (one or more playback dimensions) associated with a physical space in which playback of the audio bitstream 21 is to occur. That is, the audio playback system 16A may interface with a user operating the audio playback system 16A to identify the playback dimensions (e.g., through an interactive user interface in which the user moves around the room to identify the playback dimensions) (and/or via a remote camera mounted to capture playback of the XR scene, via a head-mounted camera to capture playback/interactions of/with the XR scene, etc.).

The audio playback system 16A may then modify, based on the playback dimension and the source dimension, a location associated with the audio element to obtain a modified location for the audio element. In this respect, the audio decoding device 24 may parse the audio element from the audio bitstream 21, which is represented in the example of FIG. 1 as the ambisonic audio elements 15 (which may represent one or more audio elements). While described with respect to the ambisonic audio elements 15, various other audio data formats may be rescaled according to various aspects of the techniques, where other audio data formats may include object-based formats, channel-based formats, and the like.

In terms of performing audio rescaling, the audio playback system 16A may determine whether a difference between the source dimension and the playback dimension exceeds a threshold difference (e.g., more than 1%, 5%, 10%, 20%, etc. difference between the source dimension and the playback dimension). If the difference between the source dimension and the playback dimension exceeds the different threshold (defined, for example, as 1%, 5%, 10%, 20%, etc.), the audio playback system 16A may then determine the rescaling factor. The audio playback system 16A may determine the rescaling factor as a function of the playback dimension divided by the source dimension.

In instances of linear rescaling, the audio playback system 16A may determine the rescaling factor as the playback dimension divided by the source dimension. For example, assuming the source dimension is 20 M and the playback dimension is 6 M, the audio playback system 16A may compute the rescaling factor as 6 M/20 M, which equals 0.3 or 30% as the rescaling factor. The audio playback system 16A may apply the audio factor (e.g., 30%) when invoking the scene manager 23.

The audio playback system 16A may invoke the scene manager 23, passing the rescaling factor to the scene manager 23. The scene manager 23 may apply the rescaling factor when processing the audio elements extracted from the audio bitstream 21. The scene manager 23 may modify metadata defining a location of the audio element in the XR scene, rescaling metadata defining the location of the audio object to obtain the modified location of the audio object. The scene manager 23 may pass the modified location to the audio renderer 22, which may render, based on the modified location for the audio element, the audio element to the speaker feeds 25. The audio renderers 22 may then output the speaker feeds 25 for playback by the audio playback system 16A (which may include one or more loudspeakers configured to reproduce, based on the speaker feeds 25, a soundfield.

The audio decoding device 24 may parse the above noted syntax elements indicating a rescale factor and an auto rescale which indicates whether auto rescaling is to be performed. When the rescale factor is specified in the manner noted above, the audio playback system 16A may obtain the rescale factor directly from the audio bitstream 21 (meaning, in this instance, without computing the rescale factor as a function of the playback dimension being divided by the source dimension). The audio playback system 16A may then apply the rescale factor in the manner noted above to obtain the modified location of the audio element.

When processing the syntax element indicative of auto rescale, the audio playback system 16A may refrain from rescaling audio elements associated with the auto rescale syntax element indicating that auto rescale is not to be performed. Otherwise, the audio playback system 16A may process audio elements associated with the audio rescale syntax element indicating that auto rescale is to be performed using various aspects of the techniques described in this disclosure for performing rescale. The auto rescale syntax element may configure the audio playback system 16A to continually apply the rescale factor to the associated audio element while the associated audio element is present in the XR scene.

Using the scaling (which is another way to refer to rescaling) provided in accordance with various aspects of the techniques described in this disclosure, the audio playback system 16A (which is another way to refer to an XR playback system, a playback system, etc.) may improve reproduction of the soundfield to modify a location of audio sources (which is another way to refer to the audio elements parsed from the audio bitstream 21) to accommodate the size of the playback space. In enabling such scaling, the audio playback system 16A may improve an immersive experience for the user when consuming the XR scene given that the XR scene more closely matches the playback space. The user may then experience the entirety of the XR scene safely within the confines of the permitted playback space. In this respect, the techniques may improve operation of the audio playback system 16A itself.

However, even when scaling is employed, there are instances where the playback location, or in other words, a real world space is irregular (e.g., slanted walls, vaulted ceilings, domes ceilings, slanted ceilings, etc.) or a representation of the real world space is incomplete (e.g., a scan or mapping of the real world space contains elements, such as furniture, lighting fixtures, etc., that prevent a complete scan or mapping of the real world space).

As such, soundfield representation generator 302 may specify, in audio bitstream 21, another syntax element (e.g., a second syntax element) indicative of a tolerance 50 for applying the rescaling factor. A content creator may define tolerance 50 or an analysis (e.g., possibly using trained artificial intelligence models, such as a neural network, statistical analysis, etc.) of the source location may result in tolerance 50. Tolerance 50 may define a percentage of the source location that remains outside of the playback location (which may also be referred to as the “playback space” or the “real world space”).

Tolerance 50 may be defined as percentages in three dimensions (e.g., a width —x-axis, a height—y-axis, and a depth—z-axis). In other words, tolerance 50 may be defined as a width tolerance, a height tolerance, and a depth tolerance. Alternatively, tolerance 50 may be defined as a minimum and a maximum (min/max) for each of the three dimensions (e.g., a width—x-axis, a height—y-axis, and a depth—z-axis). That is, tolerance 50 may be defined as the maximum and the minimum for each of the width tolerance, the height tolerance, and the depth tolerance. Using the min/max, soundfield generator device 302 may enable tolerances to be defined for irregular or incomplete representations of the real world space.

Audio decoding device 24 may obtain the syntax element indicative of tolerance 50 along with the rescale factor. Tolerance 50 (which may be used to refer to the decoded one or more syntax element(s) representative of tolerance 50) may modify application of the rescale factor to decoded ambisonic audio elements 15 (or other forms of audio data). In addition, various aspects of the techniques may enable the scene manager 23 to modify the scaling in three dimensions to accommodate irregular real world spaces.

The scene manager 23 may obtain the playback dimension associated with the physical space (or, in other words, real world space, which may also be referred to as a playback location) in which playback of audio bitstream 21 is to occur. The scene manager 23 may also obtain, as described in more detail in this disclosure, a source dimension associated with the source space (which may also be referred to as a source location) for the extended reality scene. The scene manager 23 may also obtain tolerance 50 from audio decoding device 24, which parses, in this example, tolerance 50 from audio bitstream 21.

The scene manager 23 may modify, based on the audio playback dimension, the source dimension, and tolerance 50 a location of the audio element to obtain a modified location for the audio element (e.g., represented by ambisonic audio elements 15). The scene manager 23 may first determine a rescale factor based on the playback dimension and the source dimension. The scene manager 23 may then adjust ambisonic audio elements 15 based on the rescale factor within tolerance 50. That is, the scene manager 23 may, as one example, modify the rescale factor based on tolerance 50 to obtain a modified rescale factor. The scene manager 23 may then apply the modified rescale factor to the location of the audio element (i.e., represented by ambisonic audio elements 15 in this example) to obtain a modified location of the audio element.

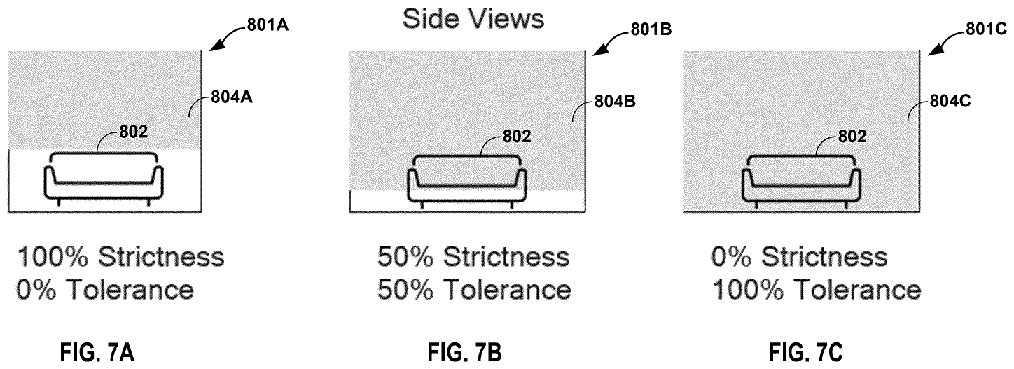

By including tolerance 50 and scaling in three dimensions, various aspects of the techniques may enable extended reality system 10 to provide a more immersive experience that can account for irregular or incomplete representations of the real world space. In enabling such scaling, extended reality system 10 may improve an immersive experience for the user when consuming the extended reality scene given that the extended reality scene more closely matches the playback space. The user may then experience the entirety of the extended reality scene safely within the confines of the permitted playback space. In this respect, the techniques may improve operation of the extended reality system itself, as described with respect to FIGS. 7A-11C.

As noted above, the audio renderer 22 may not accurately reproduce the sound field given that the source metadata (for the respective audio elements, which may be a way to generally refer to the ambisonic audio elements 15, the channel-based audio data and/or the object-based audio data) may define an origin that is not ideal within physical constraints of the playback location in which the listener is located. The content creator of audio elements 15 (which is another way to refer to the ambisonic audio data 15) may specify an origin for reproduction in the virtual environment. This origin may represent an origin for the ambisonic audio elements 15 for reproduction of the virtual environment that matches a source location (e.g., a concert venue, a stadium, an outdoor location, etc.).

The source location may have much larger dimensions (or alternatively much smaller dimensions) than the playback locations identified by the audio playback system 16A. Maintaining the origin defined by the content creator may impact rendering by the audio renderer 22 at the playback location, which again may be smaller (or possibly larger) than the source location. Rather than require users (which is another way to refer to listeners) to only operate extended reality systems in locations that permit one-to-one correspondence in terms of spacing with the source location at which the extended reality scene was captured and/or for which the extended reality scene was generated, various aspects of the techniques enable an extended reality system to scale a source location to accommodate the playback location. As such, if the source location includes the microphones 5 that are spaced 10 meters (10 M) apart, the extended reality system may scale (which is effectively a rescale given that the content creator originally defines the scale) that spacing resolution of 10 M to accommodate a scale of the playback location using the rescaling factor that is determined based on a source dimension defining a size of the source location and a playback dimension defining a size of a playback location.

However, while rescaling may be performed, the content creator may define an origin (via metadata associated with the ambisonic audio elements 15 to be reproduced) for the extended reality scene. The audio playback system 16A may use the origin to perform rescaling (which may also be referred to as a “rescaling translation”), which potentially results in incorrect audio reproduction given that the origin may not be correctly defined for a real world space (which is another way to refer to the playback location). The origin may be a global origin for both the source location and the playback location, thereby possibly resulting in incorrect rescaling that does not properly localize the audio source within the playback location (when the playback location is not the same scale as the source location).

Rather than rely solely on the global origin, the audio playback system 16A may calculate, determine, or otherwise obtain an offset 27 that adjusts the origin to possibly more accurately rescale the extended reality audio scene for the playback location. The audio playback system 16A may calculate the offset 27 based on the audio element reference origin (which is another way to refer to the global origin), where the offset 27 may realign the reference origin of the ambisonic audio elements 15 with an identified anchor point determined at the playback location by the audio playback system 16A, a listener's location (which may also be referred to as a listener position) as obtained by the audio playback system 16A, and/or a virtual world origin obtained by the audio playback system 16A. The audio playback system 16A may utilize the origin to obtain an adjusted global origin for the ambisonic audio element 15, and perform rescaling with respect to the adjusted global origin to potentially improve reproduction of the audio element and create a more immersive user experience.

As noted above, audio playback system 16A includes the scene manager 23 (which may be implemented in or configured within processing circuitry) configured to implement a renderer initializer 26 that provides additional metadata that may include the offset 27 and the scaling factor. The renderer initializer 26 may perform an audio renderer initialization stage, which may include obtaining, based on the source origin (which is another way to refer to the “global origin” or “origin”) defined by the content creator for reproduction in the virtual environment representative of the source location, the offset 27 for the playback location. The renderer initializer 26 may output the offset 27 (possibly along with the rescale factor) as additional metadata to the scene manager 23.

In addition, the renderer initializer 26 may receive, from the bitstream 21, a syntax element or other indication that configures how the offset 27 is to be obtained, where the indication may specify an intended origin from which the audio element is to be located within the playback location when rescaling the audio element. In some instances, the listener (or, in other words, the user) and/or the playback system 16A may override this intended origin. In some instances, the bitstream 21 may not explicitly include the indication specifying the intended origin, and a default intended origin may be selected.

As such, the soundfield representation generator 302 may specify this intended origin in the bitstream 21, where the intended origin is provided by the content creator (either manually or possibly through analysis of the underlying soundfield represented by audio streams 11). In some instances, the soundfield representation generator 302 may implicitly specify the intended origin (e.g., the intended origin is a default and need not be explicitly signaled as an indication in the bitstream 21, but may be implicitly specified). The intended origin may specify one of an anchor position within the virtual environment, a listener position within the virtual environment, a virtual origin for the virtual environment as reproduced within the playback location, a playback origin for the playback location.

For example, the following table may represent how the anchors are defined:

TABLE
Syntax of anchors( )

| | No. | |
|---|---|---|
| Syntax | of bits | Mnemonic |
| anchors( ) | | |
| { | | |
| anchorsCount = GetCountOrIndex( ); | | |
| for (int i = 0; i < anchorsCount; i++) { | | |
| anchorId = GetID( ); | 8..* | cstri |
| anchorLsiRef; | ng | |
| [audioSourceRescaleX, | | |
| audioSourceRescaleY, | | |
| audioSourceRescaleZ] = | | |
| GetAudioSourceRescale( ); | | |
| autoRescale; | 1 | bool |
| [toleranceXMax, | | |
| toleranceXMin, | | |
| toleranceYMax, | | |
| toleranceYMin, | | |
| toleranceZMax, | | |
| toleranceZMin] = GetTolerance( ); | | |
| } | | |
| } | | |

The renderer initializer 26 may determine the offset 27 (possibly using the specified or default intended origin) in one or more various ways. For example, the renderer initializer 26 may obtain an anchor position within the virtual environment. That is, the renderer initializer 26 may determine the anchor position as a virtual object (e.g., a virtual display, a virtual graphical user interface, a virtual “window,” etc.) within the virtual environment. The renderer initializer 26 may then obtain, based on the source origin and the anchor position (which in this instance may represent an example of a reference origin), the offset 27 for the playback location.

As another example, the renderer initializer 26 may be configured to obtain a playback origin for the playback location. The renderer initializer 26 may next obtain, based on the source origin and the playback origin, the offset 27 for the playback location. These first three examples are illustrated in more detail with respect to FIG. 12, which are discussed in more detail below.

However, while initializing the audio renderers 22 in this manner may improve reproduction of the soundfield by accounting for initial differences between the source location and the playback location, various updates in both listener position (whether in the virtual environment and/or the physical location), virtual scene change, playback location environmental changes (e.g., opening a door, a curtain, etc. in the playback locations), etc. during reproduction of the soundfield may impact auto rescale of ambisonic audio elements 15 in a manner that reduces immersion or creative capabilities. That is, the renderer initializer 26 may configure or otherwise initialize the audio renderers 22 to account for differences between the source location and the playback location, but these dynamic changes that occur during reproduction of the soundfield may reduce the immersive impact of the auto rescale operation (or otherwise limit how audio rescale is perceived).

In accordance with various aspects of the techniques described in this disclosure, the scene manager 23 may dynamically perform auto rescale during reproduction of the soundfield. The scene manager 23 may, as one example, determine that the listener has moved between two or more of the ambisonic audio elements 15, which may reside in different or overlapping regions within the virtual environment representative of the source location. The scene manager 23 may dynamically rescale (e.g., during reproduction of the soundfield), responsive to determining that the listener has moved between the two or more of the ambisonic audio elements 15 and based on the respective regions, the two or more of the ambisonic audio elements 15 to obtain at least one rescaled audio element. Rescaling between audio elements may allow for more creative soundfield reproduction while also accommodating a wide range of virtual environments (e.g., including virtual environments produced via a computing device, such as in the case of computer gaming applications).

In operation, the scene manager 23 may store metadata specified for audio elements 15 (which may be parsed from the bitstream 21 or otherwise specified by the listener, the playback system 16A, the scene manager 23, etc.). The metadata may identify a respective region in which each of the ambisonic audio elements 15 reside within the virtual environment representative of the source location. The regions may be defined for one or more of the ambisonic audio elements 15 (meaning that the region may be defined for a group of the ambisonic audio elements 15, including multiple of the ambisonic audio elements 15 within a single group).

In some instances, the soundfield representation generator 302 may specify, in the audio bitstream 21, a syntax element indicating how rescaling is to be performed when the listener moves between the two or more of the ambisonic audio elements 15. The syntax element may indicate that rescaling is to be performed with respect to one of the two or more of the ambisonic audio elements 15 into which the listener moved. The syntax element may also, in some instances, indicate that rescaling is to be performed with respect to the two or more audio elements from which the listener moved. The listener may override the auto rescale specified by the syntax element via listener/user settings.

The scene manager 23 may interface with the tracking device 306, the playback system 16A (e.g., including inputs to the playback system 16A, such as game controllers), the wearable device 800 (e.g., a head mounted display), etc. to determine that the listener (which may be wearing the wearable device 800) has moved between the two or more of the ambisonic audio elements 15. That is, when the two or more of the ambisonic audio elements 15 are in different regions within the virtual environment, the scene manager 23 may dynamically rescale the ambisonic audio elements 15 differently to potentially allow for more creative reproduction of the soundfield and/or increase audio immersion (especially as tied to video immersion created by reproduction of the virtual environment). When the two or more of the ambisonic audio elements 15 are in overlapping regions, the scene manager 23 may dynamically rescale the ambisonic audio elements 15 to the same extent (which again may be overridden via listener/user settings to allow for the different dynamic rescaling noted above).

The scene manager 23 may dynamically rescale the ambisonic audio elements 15 to adapt their locations and/or dimensions as described throughout this disclosure. The scene manager 23 may also dynamically change or otherwise update the rescale factors used when initializing the audio renderer 22 to account for the movement of the listener between the two or more of the ambisonic audio elements 15. The audio renderer 22 may next reproduce the at least one rescaled audio element to obtain the output speaker feeds 25. The output the speaker feeds 25 may also be referred to as loudspeaker feeds 25, which are used to drive a loudspeaker, a headphone speaker, and/or any other transducer (where drive refers to activating the transducer to reproduce the soundfield).

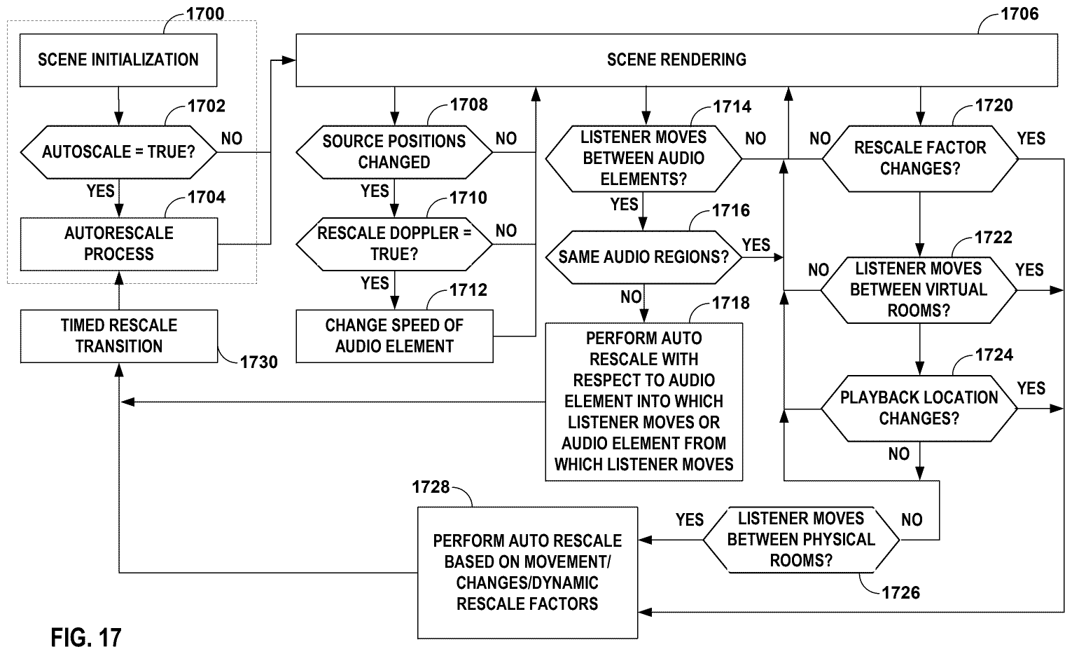

In addition, the scene manager 23 may dynamically rescale based on various movements of the listener (either or both in the virtual environment and in the physical playback location), virtual scene change, playback location environmental changes (e.g., opening/closing a door, opening/closing a curtain, etc. in the playback location), etc. during reproduction of the soundfield. Instead of assuming a static rendering accomplished by an initial renderer initialization, the scene manager 23 may instead initialize audio renderers 22 (via renderer initializer 26 as discussed in more detail throughout this disclosure) and then may continue, during reproduction of the soundfield, to adapt the auto rescale to potentially account for the various changes listed above. In this respect, the scene manager 23 may perform dynamic auto rescale that may better recreate the intent of the content creator, better account for listener preference, and/or further facilitate a more immersive experience. An example process for performing this dynamic auto rescale is described below with respect to FIG. 17.

FIG. 17 is a flowchart illustrating example operation of the scene manager of FIGS. 1A and 1B in performing various aspects of the dynamic rescale techniques described in this disclosure. The scene manager 23 may invoke renderer initializer 26 to perform scene initialization (1700), determine whether auto rescale has been enabled (e.g., via a syntax element, listener/user preference via listener/user settings, etc.) (1702), and perform the initialize auto rescale process (1704). When auto rescale has not been enabled, the scene manager 23 may not initialize the renderers 22 to perform auto rescale.

The audio renderers 22 may next perform scene rendering (1706).

The scene manager 23 may next determine the dynamic conditions that change during reproduction of the soundfield. In one example, the scene manager 23 may determine whether source positions have changed (e.g., due to the initial rescaling) (1708), which may effectively result in determining if the rescaled audio element is smaller than the initial ambisonic audio elements 15. When smaller than the initial ambisonic audio elements 15, the scene manager 23 may determine whether a rescale doppler setting has been enabled (e.g., true) (1710), which may be specified as a syntax element in the bitstream 21, defined by the listener/user settings, etc. The scene manager 23 may then reduce, responsive to determining that the rescaled audio element is smaller than the audio element (and possible if the rescale doppler is enabled), a speed associated with the audio element to reduce a doppler effect (1712). In some instances, the scene manager 23 may increase, responsive to determining that the rescaled audio element is smaller than the audio element, a speed associated with the audio element to maintain the doppler effect. The scene manager 23 may, in some examples, increase, responsive to determining that the rescaled audio element is not smaller than the ambisonic audio elements 15, a speed associated with the audio element to maintain the doppler effect.

In other words, audioSourceRescale is a set of 3 floating point values {1 1 1}-which means the audio element positions do not change, these are multiplication factors, which currently are set during the encoding once. The tolerance values which scale the multiplications values is set once during initialization of the renderer 22. In this instance, the scene manager 23 may determine how to handle the doppler effect. The scene manager 23 may perform the following:
Doppler could be disabled after rescaling;
If the scene is rescaled down (smaller size) then doppler effects of objects will be less. If listener moves then they will be exaggerated, but only if content creator wants hyper-realism, which could change the speed of sound;

Or the scene manager 23 may determine how to retain original doppler after rescaling by, as one example, to perform the following:
Listener position and movements are the same regardless of rescaling;
Default may be to match what the user sees. No need to de-rescale source positions when sending to doppler effect stage?
Example Case 1: Car moves closely past the listener where after rescaling the car will move slower relative to the listener so doppler is de-emphasized compared to original scene.
Example Case 2: Jet moves above the listener where after rescaling it may move close to the listener's head emphasizing doppler effect.
Example Case 3: listener walks towards/away from sound sources where the listener now moves faster (for a smaller rescaled scene) than would have in the original scene so doppler is emphasized and matches what the listener sees.

In addition, the scene manager 23 may determine whether the listener moves between the ambisonic audio elements 15 (1714). The scene manager 23 may rescale, responsive to determining that the listener has moved between the ambisonic audio elements 15 and based on respective regions defined for each of the ambisonic audio elements 15. The respective regions may be defined via metadata associated with the ambisonic audio elements 15, where the respective regions may indicate where each of the ambisonic audio elements 15 reside within the virtual environment representative of the source location.

In instances where the scene manager 23 determines that the respective regions are same (or in other words, different regions, e.g., not overlapping) (1716), the scene manager 23 may rescale, responsive to determining that the listener has moved between the ambisonic audio elements 15 and determining that the respective regions are different, the ambisonic audio elements 15 to obtain the at least one rescaled audio element. The scene manager 23 may perform the rescale with respect to the two or more of the ambisonic audio elements 15 into which the listener has moved or the two or more of the ambisonic audio elements 15 from which the listener has moved. In these instances, the scene manager 23 may individually rescale the two or more ambisonic audio elements 15 differently than one another to obtain the at least one rescaled audio element.

However, in instances where the scene manager 23 determines that the respective regions are not different (e.g., overlap), the scene manager 23 may rescale, responsive to determining that the listener has moved between the two or more of the ambisonic audio elements 15 and determining that the respective regions overlap, the ambisonic audio elements 15 to obtain corresponding two or more scaled audio elements. The scene manager 23 may rescale the two or more of the ambisonic audio elements 15 by the same amount. That is, the scene manager 23 may rescale the two or more of the ambisonic audio elements 15 the same amount and refrain from individually rescaling the two or more of the ambisonic audio elements 15. In this respect, the scene manager 23 may perform auto rescale with respect to the ambisonic audio elements 15 into which the listener moves or the ambisonic audio elements 15 from which the listener moves (1718).

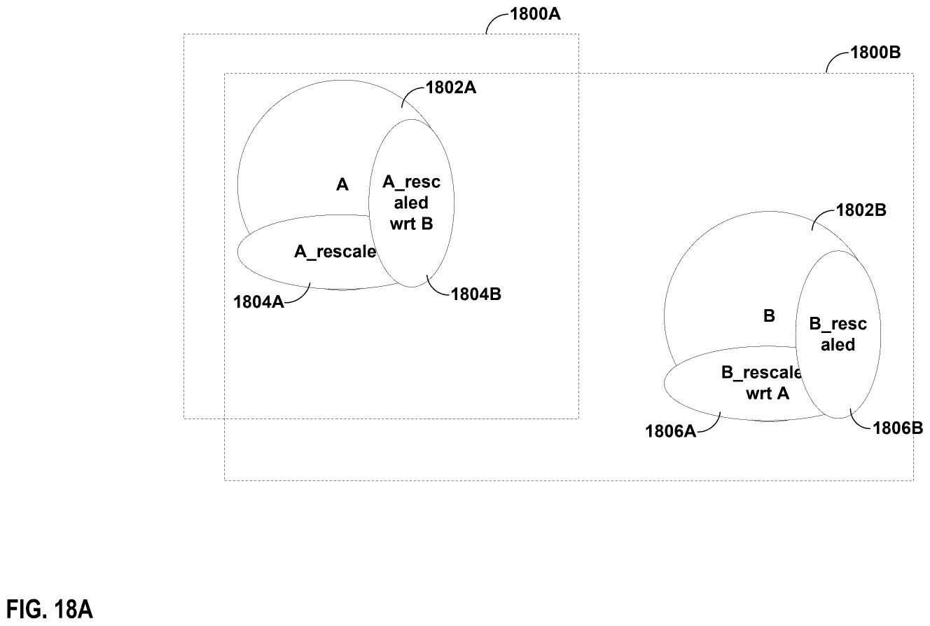

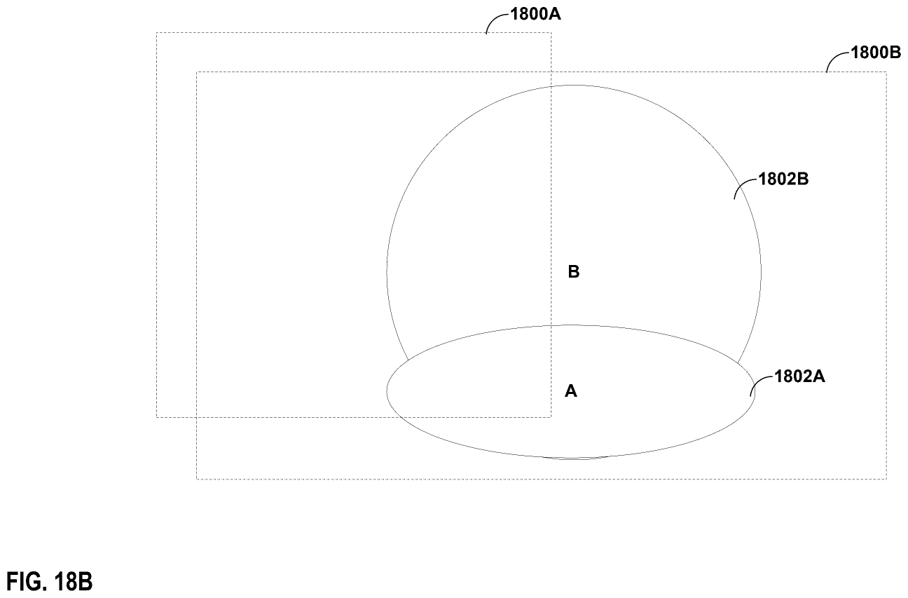

FIGS. 18A and 18B are diagrams illustrating an example of auto rescale responsive to listener movement between audio elements in accordance with various aspects of the dynamic rescale techniques. In the example of FIG. 18A, audio element 1802A is associated with a region 1800A, while audio element 1802B is associated with a region 1800B. The scene manager 23 may rescale audio element 1802A with respect to the region 1800A to obtain rescaled audio element 1804A or rescaled audio element with respect to the region 1800B to obtain rescaled audio element 1804B. The scene manager 23 may rescale audio element 1802B with respect to the region 1800A to obtain rescaled audio element 1806A or rescale audio element 1802B with respect to the region 1800A to obtain rescaled audio element 1806B.

In the example of FIG. 18B, the audio element 1802A overlaps the audio element 1802B sharing the same region that spans the regions 1800A and 1800B. The scene manager 23 may determine that the audio elements 1802A and 1802B that overlap in terms of regions and not individually auto rescale the audio elements 1802A and 1802B (or, in other words, both share the same region so no difference in handling rescaling between the audio elements 1802A and 1802B).

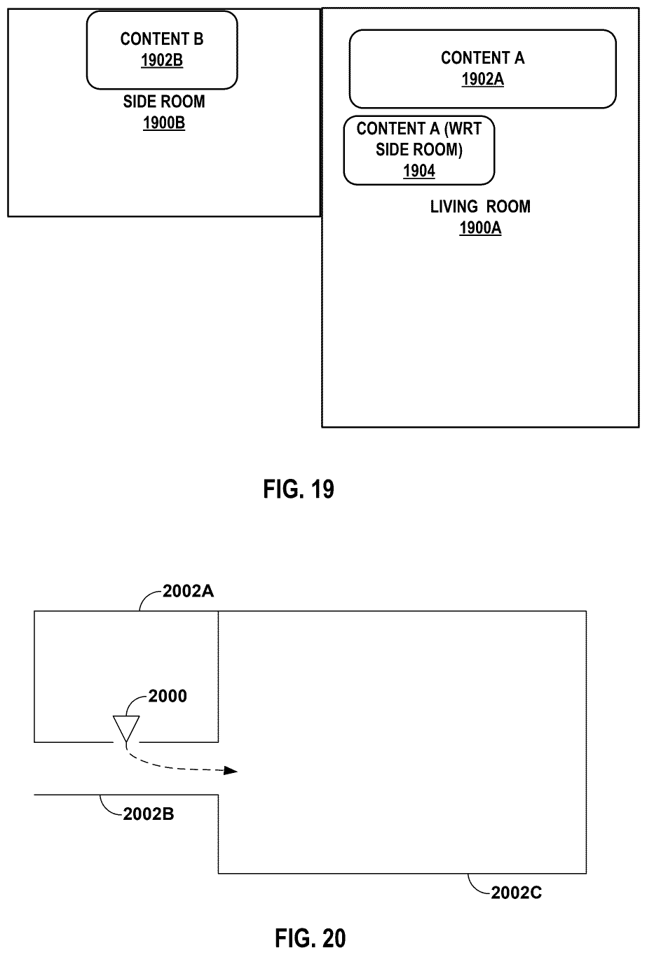

Referring back to FIG. 17, the scene manager 23 may determine whether the rescaling factors have changed during reproduction of the soundfield (1720). The scene manager 23 may adapt the renderers 22 to reinitialize the renderer 22 to account for the updated rescaling factors. The scene manager 23 may also determine whether the listener moves between virtual rooms (of the virtual environment) (1722), whether the physical playback location has changed (1724), and/or whether the listener moves between physical rooms (1726). The scene manager 23 may next perform auto rescale based on the movement/changes/dynamic rescale factors (1728). FIG. 19 is a diagram illustrating an example of the auto rescale when the listener moves between physical rooms in accordance with various aspects of the dynamic rescale techniques described in this disclosure.

In the example of FIG. 19, the listener may move between physical locations 1900A (e.g. a living room 1900A) and 1900B (e.g., a side room 1900B), where different physical locations 1900A and 1900B may be associated with different audio elements 1902A (e.g., content A 1902A) and 1902B (e.g., content B 1902B). In this example, the listener starts in the living room 1900A and the scene manager 23 configures rescaling for living room 1900A (which may also be referred to as living room region 1900A) during renderer initialization. The listener may move to the side room 1900B, where the scene manager 23 rescales with the dimensions of the new room (which is another way to refer to side room 1900B). In this instance, the sources shift. Further, multiple regions may be defined in either bitstream's AudioScene or multiple LSDFs loaded (one LSDF for each of the rooms 1900A and 1900B).

In some instances, the scene manager 23 performs rescaling with the new room's dimensions during initialization of new content (e.g., the content B 1902B. In one instance, the listener stopped hearing stage A when moving to the side room 1900B to listen to the content B 1902B. The scene manager 23 may, in some examples, when the listener wants to continue listening to audio from the initial content A 1902A, leaving the rescale as originally initialized or rescaling with respect to the side room 1900B (and thereby obtaining rescaled content A (rescaled with respect to side room) 1904.

FIG. 20 is a diagram illustrating an example of auto rescale performed when the listener moves between virtual rooms in accordance with various aspects of the dynamic rescale techniques described in this disclosure. As shown in the example of FIG. 20, the listener 2000 moves from a virtual room 2002A through a virtual room 2002B (e.g., a hallway 2002B) into a virtual room 2002C.

In the example of FIG. 20, the listener may start in the virtual room 2002A (e.g., an office 2002A) and move to the virtual room 2002C (e.g., a lobby 2002C) via the hallway 2002B. The relatively smaller office 2002A may not require rescaling, but as the listener moves down the hallway 2002B, the scene manager 23 may rescale to allow the listener to travel to the lobby 2002C (where the rescale may be to the size of a minimap, which may be assumed to be illustrated by FIG. 20). The scene manager 23 may perform coordinate handling to ensure continuity between rooms 2002A-2002C (involving possibly re-orientation and/or translation). In some instances, the room to which the listener may transition may be inaccessible if the listener walked next to a wall.

Referring back to the example of FIG. 17, the scene manager 23 may handle changes to the physical location that may alter or otherwise change the dimensions of the physical location (e.g., opening/closing a curtain, opening/closing a door). The scene manager 23 may interface with the wearable device 800 to perform a mesh rescanning where the scene manager 23 may present an application programming interface or other dynamic interface by which to pass the rescale factors to the renderer 22 when a scene event occurs. In this example, the scene manager 23 may perform geometric processing (e.g., mesh, voxels, primitive shapes, etc.).

In addition, the scene manager 23 may dynamically change the rescale factors as noted above. These changes may be applied during scene initialization (which may occur during reproduction of the soundfield), where for example the listener may start to experience a scene via a zoom-out effect. In some instances, there is an acclimation whenever there is a transition that may include a timed rescale translation (1730), which may apply to any of the various aspects of the auto rescale techniques described above.

FIG. 12 is a block diagram illustrating example physical spaces in which various aspects of the offset-based rescaling techniques are performed in order to facilitate increased immersion while consuming extended reality scenes. In the example of FIG. 12, a source space 5500A (which may also be referred to as a source location 5500A) and a physical playback space (PPS) 5500B (which may also be referred to as a playback location 5500B) is shown.

The source space 5500A represents a concert venue (in this example) from which a stage 5502 emits an audio soundfield 5504 via loudspeakers (which are not shown in the example of FIG. 12 for ease of illustration purposes). The source space 5500A also includes microphones 5506A and 5506B (“microphones 5506”) that capture audio data representative of the audio soundfield 5504. The content capture device 300 (shown in the example of FIG. 1A) may capture the audio data representative of the audio soundfield 5504 in various audio formats, such as a scene-based format (that may be defined via HOA audio formats), object-based formats, channel-based formats, and the like.

The soundfield representation generator 302 may generate, based on the audio data, the audio bitstreams 21 that specifies audio elements (in one or more of the audio formats noted above). The soundfield representation generator 302 may specify, in the audio bitstreams 21, the above noted syntax elements, such as the rescale syntax element that specifies a rescale factor to translate a position (or, in other words, location) of audio elements with respect to (often denoted as “w.r.t.”) the associated audio element and an auto rescale syntax element that specifies whether or not (e.g., a Boolean value) to generate a rescale factor based on environment dimensions (e.g., the dimensions of the physical location 5500B, which may also be referred to as a playback location).

In the example of FIG. 12, the source space 5500A is square with dimensions of 20 M in width and 20 M in length. Although not shown, the source space 5500A may also include a height dimension (e.g., 20 M). The soundfield representation generator 302 may specify, in the audio bitstream 21, one or more syntax elements that specify one or more of the width, space, and/or height of the source space 5500A. The soundfield representation generator 302 may specify the one or more syntax elements that specify one or more of the width, space, and/or height of the source space 5500A using any form of syntax elements, including referential syntax elements that indicate one or more dimensions are the same as other dimensions of the source space 5500A.

Microphones 5506 may capture the audio data representative of the audio soundfield 5504 in a manner that preserves an orientation, incidence of arrival, etc. of how the audio soundfield 5504 arrived at each individual microphone 5506. Microphones 5506 may represent an Eigenmike® or other 3D microphone capable of capturing audio data in 360 degrees to fully represent the audio soundfield 5504. In this respect, microphones 5506 may represent an example of microphones 5 shown in the example of FIGS. 33A and 33B. Microphones 5506 may therefore generate audio data reflective of a particular aspect of the audio soundfield 5504, including an angle of incidence 5508A (for microphone 5506A, but there is also an angle of incidence 5508B that is not shown for ease of illustration purposes with respect to microphone 5506B).

In this way, the soundfield generator device 302 may generate the audio bitstream 21 to represent the audio elements captured by microphones 5506 in 3D so that reproduction of the audio soundfield 5504 may occur in 6DOF systems that provide a highly immersive experience. However, the PPS 5500B has significantly different dimensions in that the dimensions for PPS 5500B are 6 M for width and 6 M for length (and possibly 6 M for height or some other height).

In this example, the microphones in the source space 5500A are located approximately 10 M apart, while the PPS 5500B includes loudspeakers 5510A and 5510B (“loudspeakers 5510”) spaced about, or approximately, 3 M apart. The audio playback system 16A may receive the audio bitstream 21 and parse (e.g., by invoking the audio decoding device 24) the audio elements representative of the audio soundfield 5504 from the audio bitstream 21. The audio playback system 16A may also parse (e.g., by invoking the audio decoding device 24) the various syntax elements noted above with respect to the audio element relative rescale and auto rescale.

In initializing the audio playback system 16A for playback in the PPS 5500B, the user of the content consumer device 14 may enter the dimensions (e.g., one or more of height, length, and width) of the PPS 5500B via, as one example, a user interface or via having the user move about the PPS 5500B. In some examples, the content consumer device 14 may automatically determine the dimensions of the PPS 5500B (e.g., using a camera, an infrared sensing device, radar, lidar, ultrasound, etc.).

In any event, the audio playback system 16A may obtain both the dimensions of the source space 500A as well as the dimensions of the PPS 5500B. The audio playback system 16A may next process the syntax elements for relative rescale and auto rescale to identify how and which audio elements specified in the audio bitstream 21 are to be rescaled. Assuming in this example that the audio soundfield 5504 is to be rescaled as indicated by the syntax elements, the audio playback system 16A may determine, based on the dimension of the source space 5500A and the dimension of the PPS 5500B, a rescale factor 5512.

The audio playback system 16A may, as noted above, also determine the offset relative to a source origin 5550 (which may also be referred to as a virtual environment origin for virtual environments that are not captured in a physical source location/space). The bitstream 21 may define the source dimensions for the virtual environment (e.g., the source dimensions of the source space 5500A) relative to the source origin 5550, where the source origin may be specified in the bitstream 21 or implied by virtue of being static (e.g., the upper left corner of the source space 5500A in the example of FIG. 12). The audio playback system 16A may next determine, based on the source origin 5550 and one of an anchor position 5552 and a playback space origin 5554, which may be obtained in the manner described herein (e.g., automatically by the audio playback system 16A).

In the example of FIG. 12, the audio playback system 16A may determine the rescale factor as the width of the PPS 5500B (6 M) divided by the width of the source space 5500A (20 M), which results in a rescale factor of 0.3 or, in other words, 30%. The audio playback system 16A may next modify a location of the audio element representing the audio soundfield 5504 captured by the microphone 5506A to obtain a modified location of the audio soundfield 5504 captured by the microphone 5506A that is 30% closer to a reference location (e.g., a reference location for the center (0, 0, 0) of the XR scene, or in other words, an XR world) compared to a location of the microphone 506A relative of the center of the XR scene/world.

That is, the audio playback system 16A may multiply the location of the audio element representing the audio soundfield 5504 (after applying the offset as described above with respect to the example of FIG. 1A) as captured by the microphone 5506A by the rescale factor to obtain the modified location of the audio element representing the audio soundfield 5504 as captured by the microphone 5506A. Given that the approximate dimensions of the source space 5500A are uniform compared to the dimensions of the PPS 5500B (meaning that the width and length of the source space 5500A are linearly equivalent in proportion to the dimensions of the PPS 5500B), the audio playback system 16A may apply the rescale factor to modify the location of the audio element representing the audio soundfield 5504 as captured by the microphone 5506A (after possibly applying the offset as described above with respect to FIG. 1A) without altering an angle of incidence 5508B during reproduction/playback by loudspeakers 5510.

Using the scaling (which is another way to refer to rescaling) provided in accordance with various aspects of the techniques described in this disclosure, the audio playback system 16A (which is another way to refer to an XR playback system, a playback system, etc.) may improve reproduction of the soundfield to modify a location of audio sources (which is another way to refer to the audio elements parsed from the audio bitstream 21) to accommodate the size of the PPS 5500B. In enabling such scaling, the audio playback system 16A may improve an immersive experience for the user when consuming the XR scene given that the XR scene more closely matches the playback space. The user may then experience the entirety of the XR scene safely within the confines of the permitted playback space. In this respect, the techniques may improve operation of the audio playback system 16A itself.

Returning back to the example of FIG. 1A, and as another example, the renderer initializer 26 may obtain listener position in the manner described above within the virtual environment. The renderer initializer 26 may next obtain, based on the source origin and the listener position, the offset 27 for the playback location. More information regarding the listener position is provided below with respect to the example of FIG. 12.

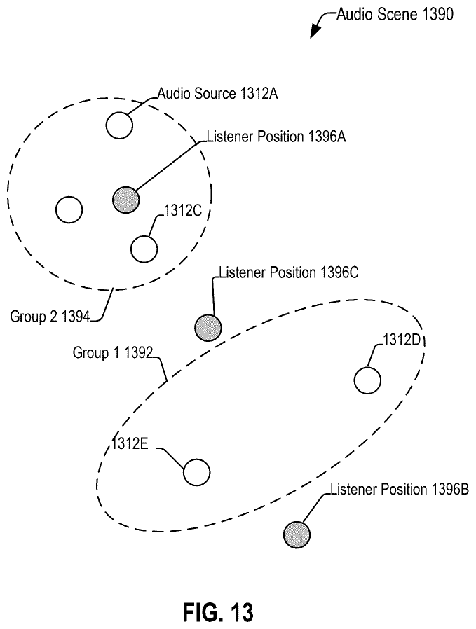

FIG. 13 is a block diagram illustrating an example audio scene in which offset-based rescaling may be performed according to various aspects of the techniques. In a particular implementation, the source device 12 corresponds to an encoder device that receives audio data from multiple audio sources, such as the set of audio streams 11 (which is another way to refer to scene-based audio data 11), and encodes the audio data for transmission to the audio playback system 16A via a bitstream 21. In an example, the audio data encoded by the source device 12 and included in the bitstream 21 includes ambisonics data and corresponds to at least one of two-dimensional (2D) audio data that represents a 2D sound field or three-dimensional (3D) audio data that represents a 3D sound field. As used herein, “ambisonics data” includes a set of one or more ambisonics coefficients that represent a sound field. In another example, the audio data is in a traditional channel-based audio channel format, such as 5.1 surround sound format. In another example, the audio data includes audio data in an object-based format.

The source device 12 also obtains source metadata (e.g., source location and orientation data) associated with the audio sources 1312 (shown in the example of FIG. 12), assigns the audio sources 1312 to one or more groups based on one or more source spacing metrics, assigns a rendering mode to each group, and sends group metadata associated with the one or more groups to the audio playback system 16A. The group metadata can include an indication of which audio sources are assigned to each group, the source spacing metric(s), the rendering mode(s), other data corresponding to audio source groups, or a combination thereof. In some implementations, one or more components of the group metadata is transmitted to the audio playback system 16A as bits in the bitstream 21. In some examples, one or more components of the group metadata can be sent to the audio playback system 16A via one or more syntax elements, such as one or more elements of a defined bitstream syntax to enable efficient storage and streaming of the group metadata.

The audio streaming device 12 includes one or more processors that are configured to perform operations associated with audio processing. To illustrate, the one or more processors are configured, during an audio encoding operation, to obtain the set of audio streams 11 associated with the set of audio sources 1312. For example, the audio sources 1312 can correspond to microphones (such as the microphones 5) that may be integrated in or coupled to the audio streaming device 12. To illustrate, in some implementations, the audio streaming device 12 includes the one or more microphones 5 that are coupled to the one or more processors and configured to provide microphone data representing sound of at least one of the audio sources 1312.

The one or more processors are configured to obtain group assignment information indicating that particular audio sources in the set of audio sources 1312 are assigned to a particular audio source group, the particular audio source group associated with a source spacing condition. According to an aspect, the one or more processors are configured to receive source position information indicating the locations of each of the audio sources 1312 and to perform a spacing-based source grouping based on a source spacing condition to generate the group assignment information. In an example, audio sources 1312 (and/or audio streams 11 of the audio sources 1312) that satisfy the source spacing condition are assigned to a first group (or distributed among multiple first groups), and audio sources 1312 (and/or audio streams 11 of the audio sources 1312) that do not satisfy the source spacing condition (or that satisfy another source spacing conditions) are assigned to a second group (or distributed among multiple second groups). The group assignment information includes data that indicates which of the audio sources 1312 is assigned to which of the groups. For example, each group can be represented by a data structure that includes a group identifier (“groupID”) of that group and may also include an indication of which audio sources 1312 (and/or audio streams 11) are assigned to that group. In another example, the group assignment information can include a value associated with each of the audio sources 1312 that indicates which group, if any, the audio source 1312 belongs to.

According to an aspect, the source spacing condition corresponds to whether or not a source spacing metric associated with spacing between the audio sources 1312 satisfies one or more thresholds. In a particular example, the one or more processors of the source device 12 are configured to generate the group assignment information at least partially based on comparisons of one or more source spacing metrics to a threshold. To illustrate, the one or more source spacing metrics can include distances between the audio sources 1312, a source position density of particular audio sources 1312, or a combination thereof.

The one or more processors of the source device 12 are configured to generate output data that includes the group assignment information and an encoded version of the set of audio streams 11. For example, the source device 12 can include a modem that is coupled to the one or more processors and configured to send the output data to a decoder device, such as by sending the group assignment information and an encoded version of the audio streams 11 to the audio playback system 16A via the bitstream 21.

Optionally, in some implementations, the one or more processors of the source device 12 are also configured to determine a rendering mode for each particular audio source group and include an indication of the rendering mode in the output data. In an example, the one or more processors of the source device 12 are configured to select the rendering mode from multiple rendering modes that are supported by a decoder device, such as the headphones 104 (and/or a different audio playback device). For example, the multiple rendering modes can include a baseline rendering mode in which signal processing, source direction analysis, and source interpolation are performed in a frequency domain, and mode in which distance-weighted time domain interpolation is performed. The baseline rendering mode can correspond to a first mode and the distance-weighted time domain interpolation can correspond to a second mode that are supported by a renderer 22 of the audio playback system 16A.

The group-based rendering mode assignment generates rendering mode information that indicates which rendering mode is assigned to which group. For example, the rendering mode for a group can be included as a data value in a data structure for that group. To illustrate, a first data structure for the first group 1392 can include a group identifier having a value of ‘1’ indicating the first group 1392 and a rendering mode indicator having a first value (e.g., a Boolean value of ‘0’ when only two rendering modes are supported or an integer value of ‘1’ when more than two modes are supported) indicating the first mode. A second data structure for the second group 1394 can include a group identifier having a value of ‘2’ indicating the second group 1394 and a rendering mode indicator having a second value (e.g., a Boolean value of ‘1’ or an integer value of ‘2’) indicating the second mode.

An illustrative, non-limiting example of a bitstream syntax associated with higher order ambisonics groups (hoaGroups) is shown in Table 1. In Table 1, a value of parameter hoaGroupLC is read from the bitstream for each hoaGroup. The hoaGroupLC parameter is Boolean: a ‘0’ value indicates that a baseline rendering mode is to be used for the group, and a ‘1’ value indicates that a low-complexity rendering mode is to be used.

TABLE 1

| Syntax | No. of bits |
|---|---|
| hoaGroups( ) | |
| { | |
| hoaGroupsCount = GetCountOrIndex( ); | |
| for (int i = 0; i < hoaGoupsCount; i++) { | |
| hoaGroupId = GetID( ); | |
| hoaGroupLC; | 1 |
| ... | |
| } | |
| } | |

In a particular implementation, the audio playback system 16A corresponds to a decoder device that receives the encoded audio data (e.g., the audio streams 11) from the audio streaming device 12 via the audio bitstream 21. The audio playback system 16A also obtains metadata associated with the audio data from the audio streaming device 12, such as the source metadata (e.g., source location and orientation data) and the group metadata (e.g., the group assignment information, the source spacing metric(s), the rendering mode(s), or a combination thereof). In some implementations, one or more components of the group metadata, the source metadata, or both, is extracted from bits sent in the audio bitstream 21. In some examples, one or more components of the group metadata, the source metadata, or both, can be received from the audio streaming device 12 via one or more syntax elements.

The audio playback system 16A renders the received audio data to generate an output speaker feeds 25 (and/or other audio signals) based on a listener position 1396, the group assignment information, and the rendering mode information. For example, the audio playback system 16A can select one or more of the audio sources 1312 for rendering based on the listener position 1396 relative to the various audio sources 1312, based on types of sound represented by the various audio streams 11 (e.g., a determined by one or more classifiers at the audio streaming device 12 and/or at the audio playback system 16A), or both. The audio sources 1312 that are selected can be included in one or more groups, and the audio streams 11 of the selected audio sources 1312 in each group can be rendered according to the rendering mode assigned to that group.

The audio playback system 16A includes one or more processors (not shown in the example of FIG. 1A) that are configured to perform operations associated with audio processing. To illustrate, the one or more processors of the audio playback system 16A are configured, during an audio decoding operation, to obtain the set of audio streams 11 associated with the set of audio sources 1312 (as represented by ambisonic audio elements 15). At least one of the set of audio streams 11 is received via the audio bitstream 21 from an encoder device (e.g., the audio streaming device 12). In an example, the audio playback system 16A includes a modem that is coupled to the one or more processors and configured to receive at least one audio stream 11 of the set of audio streams 11 via the audio bitstream 21 from the audio streaming device 12.

The one or more processors of the audio playback system 16A are configured to obtain the group assignment information indicating that particular audio sources in the set of audio sources 1312 are assigned to a particular audio source group, the particular audio source group associated with the source spacing condition. The group assignment information can be received via the audio bitstream 21 (e.g., in the group metadata). In some implementations, the audio playback system 16A also updates the received group assignment information.

The one or more processors of the audio playback system 16A are configured to obtain a listener position 1396 associated with a pose of a user of the audio playback system 16A (also referred to as a “listener”). For example, in some implementations, the audio playback system 16A includes the wearable device 800 that includes or is coupled to one or more sensors (e.g., tracking device 306 shown in the example of FIG. 1A) configured to generate sensor data indicative of a movement of the audio playback system 16A, a pose of the audio playback system 16A, or a combination thereof. As used herein, the “pose” of the audio playback system 16A (or of the user's head) indicates a location and an orientation of the audio playback system 16A (or of the user's head), which are collectively referred to as the listener position 1396. The one or more processors of the audio playback system 16A may use the listener position 1396 to select which of the audio streams 11 (as represented by ambisonic audio elements 15) to render based on the listener's location, and may also use the listener position 1396 during rendering to apply rotation, multi-source interpolation, or a combination thereof, based on the listener's orientation and/or location in the audio scene 1390.

The one or more sensors include one or more inertial sensors such as accelerometers, gyroscopes, compasses, positioning sensors (e.g., a global positioning system (GPS) receiver), magnetometers, inclinometers, optical sensors, one or more other sensors to detect acceleration, location, velocity, angular orientation, angular velocity, angular acceleration, or any combination thereof, of the audio playback system 16A. In one example, the one or more sensors include GPS, electronic maps, and electronic compasses that use inertial and magnetic sensor technology to determine direction, such as a 3-axis magnetometer to measure the Earth's geomagnetic field and a 3-axis accelerometer to provide, based on a direction of gravitational pull, a horizontality reference to the Earth's magnetic field vector. In some examples, the one or more sensors include one or more optical sensors (e.g., cameras) to track movement, individually or in conjunction with one or more other sensors (e.g., inertial sensors).

The resulting output speaker feeds 25 is provided for playout by speakers. According to some aspects, the speakers are earphone speakers and the output speaker feeds 25 corresponds to a binaural signal. For example, the renderer 22 can be configured to perform one or more sound field rotations based on orientations of the audio sources 1312 and/or the interpolated audio sources and the orientation of the listener and to perform binauralization using head related transfer functions (HRTFs) to generate a realistic representation of the audio scene 1390 for a user wearing earphones and based on the particular location and orientation of the listener in the audio scene 1390 relative to the audio sources 1312.

Although the above examples describe rendering audio associated with five audio sources 1312 that are grouped into two groups, it should be understood that the present techniques can be used with any number of audio sources 1312 that are grouped into any number of groups. According to some implementations, rendering at the audio playback system 16A can be limited to a set number of audio sources 1312 per group to be rendered, such as three audio sources per group, as a non-limiting example. The rendering mode selection can include comparing locations of each of the audio sources 1312 in a group to the location of the listener to select the set number (e.g., three) of audio sources from the group that are closest to the listener location. The rendering mode selection (as implemented by the renderer generation unit 32 can also select which group to render from multiple groups that capture the same sound (e.g., the waterfall) based on the listener position 1396.

Although examples included herein describe the audio streams 11 as corresponding to audio data from respective microphones, in other examples one or more of the audio streams 11 may correspond to a portion of one or more of media files, audio generated at a game engine, one or more other sources of sound information, or a combination thereof. To illustrate, the audio streaming device 12 may obtain one or more of the audio streams 11 from a storage device coupled to the one or more processors or from a game engine included in the one or more processors. As another example, in addition to receiving the audio streams 11 via the audio bitstream 21, the audio playback system 16A may obtain one or more audio streams locally, such as from a microphone coupled to the audio playback system 16A from a storage device coupled to the one or more processors, or from a game engine included in the one or more processors.

Although in some examples the audio playback system 16A is described as a headphone device for purpose of explanation, in other implementations the audio playback system 16A (and/or the audio streaming device 12) is implemented as another type of device. In some implementations, the audio playback system 16A (e.g., the one or more processors), the audio streaming device 12 (e.g., the one or more processors), or both, are integrated in a headset device, such as depicted in FIGS. 5A and/or 5B. In an illustrative example, the headset device corresponds to at least one of a virtual reality headset, a mixed reality headset, or an augmented reality headset. In some implementations, the audio playback system 16A (and/or the audio streaming device 12) is integrated in at least one of a mobile phone or a tablet computer device, or a camera device. In some implementations, the audio playback system 16A (and/or the audio streaming device 12) is integrated in a wireless speaker and voice activated device. In some implementations, the audio playback system 16A (and/or the audio streaming device 12) is integrated in a vehicle.

Although various examples described for the system 10, and also for systems depicted in the following figures, correspond to implementations in which the output speaker feeds 25 is a binaural output signal, in other implementations the output speaker feeds 25 has a format other than binaural. As an illustrative, non-limiting example, in some implementations the output speaker feeds 25 corresponds to an output stereo signal for playout at loudspeakers that are integrated in or coupled to the audio playback system 16A (or for transmission to another device). In other implementations, the output speaker feeds 25 provided by the one or more processors may have one or more other formats and is not limited to binaural or stereo. More information regarding grouping-based rendering is described in U.S. Provisional Application No. 63/512,482, filed on Jul. 7, 2023.

Returning to the example shown in FIG. 1A, the renderer initializer 26 may, as yet another example, obtain a virtual origin for the virtual environment (which may be defined by the listener, automatically by the audio playback system 16A, or by other automatic or preset ways) as reproduced within the playback location. The renderer initializer 26 may obtain, based on the source origin and the virtual origin, the offset 27 for the playback location.

The scene manager 23 may receive the offset 27 (again, possibly along with the rescale factor) as additional metadata. That is, the scene manager 23 may present an application programming interface (API) or other type of interface (including hardware-based interfaces when implemented solely in hardware) that is extended to facilitate definition of the offset 27 (and again, the rescaling factor). The scene manager 23 may perform, either with or withing scene-based grouping, rescaling with respect to the ambisonic audio elements 15 (as decoded from the audio bitstream 21) based on the obtained offset 27. More information regarding rescaling can be found in U.S. patent application Ser. No. 18/045,839, entitled “SCALING AUDIO SOURCES IN EXTENDED REALITY SYSTEMS,” filed Oct. 12, 2022. The audio playback system 16A may next reproduce, based on the offset 27, the ambisonic audio elements 15 to obtain the output audio signal 25 (which is another way to refer to the speaker feeds 25).

Alternatively, the renderer initializer 26 may offset the source origin locally and perform rescaling to initialize the audio renderer 22. Initializing the audio renderer 22 may result in adapting the audio renderer 22 to configure various translations to expand or reduce the rendering of the sound field. In this instance, the renderer initializer 26 may adapt the transforms and/or translations (e.g., coefficients involved in the translations and/or rendering modes) to alter rendering of the ambisonic audio elements 15 to relocate (or, in other words, scale or rescale) the location of ambisonic audio elements 15 to potentially more effectively recreate the sound field intended by the content consumer within the physical location in which the virtual environment is being presented.

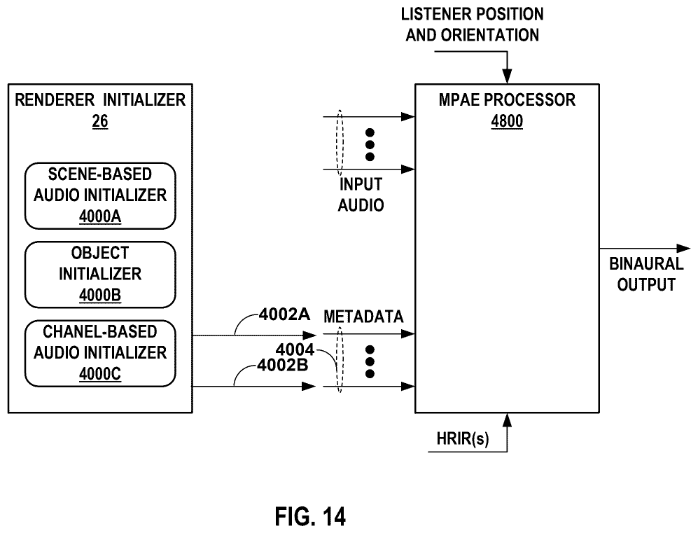

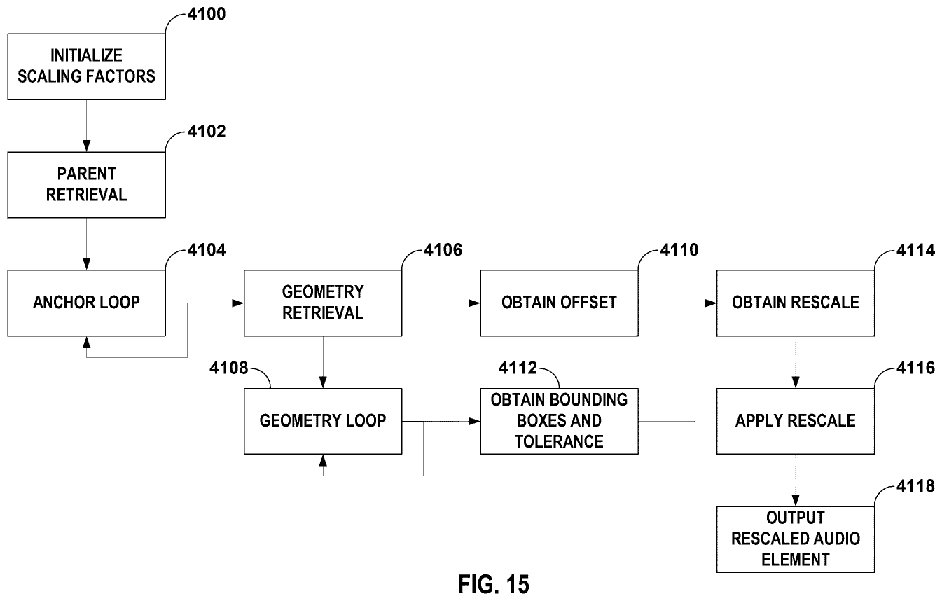

Using the offset 27 for scaling provided in accordance with various aspects of the techniques described in this disclosure (which may be referred to as “offset scaling techniques”), the audio playback system 16A may improve reproduction of the sound field to modify the origin used during scaling to accommodate the size of the playback space. In enabling such scaling, the audio playback system 16A may improve the immersive experience for the user when consuming the extended reality scene given that the extended reality scene more closely matches a geometry of the playback location (which may also be referred to as a “playback space”). The user may then experience the entirety of the extended reality scene safely within the confines of the permitted playback space. In this respect, the techniques may improve operation of the audio playback system 16A itself (which may represent an example of an XR playback device. Additional information concerning offset-based rescaling is described with respect to the example of FIGS. 14 and 15.

FIG. 14 is a block diagram illustrating the renderer initializer of FIG. 1 in more detail that is configured to implement the offset-based scaling techniques in more detail. In the example of FIG. 14, the renderer initializer 26 may include a number of different initializers 4000A-4000C (which may generally be referred to as “initializers 4000”) configured to perform various aspects of the offset-based scaling techniques described in this disclosure.

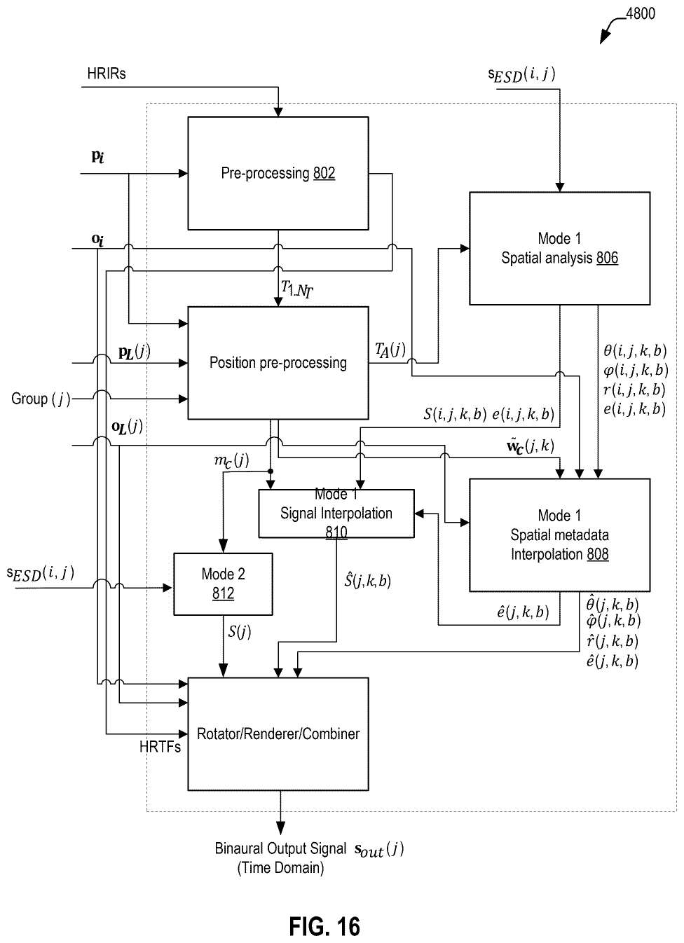

The renderer initializer 26 may invoke a scene-based audio initializer 4000A responsive to the audio bitstream 21 specifying that the bitstream includes HOA audio data (or other scene-based audio formats). The audio bitstream 21 may define the source origin for representing the sound field in the virtual environment that reproduces the source location. The scene-based audio initializer 4000A may operate with respect to the scene-based audio data to determine, based on the playback location, a rescale offset 4002A to the origin in the manner described above with respect to FIG. 1. The scene-based audio initializer 4000A may also obtain and output a rescale factor 4002B as described in more detail below. The scene-based audio initializer 4000A may output the rescale offset 4002A (which may represent an example of the offset 27 shown in the example of FIG. 1A) and the rescale factor 4002B as additional metadata 4004 to multi-point audio element processor 4800 (which is described above in more detail with respect to the example of FIG. 16). In other words, the multi-point audio element (MPAE) processor 4800 may represent an example of a portion of scene manager 23 as noted above with respect to the example of FIG. 1A.

The renderer initializer 26 may also include an object initializer 4000B that the renderer initializer 26 may invoke when the audio bitstream 21 indicates that the ambisonic audio elements 15 include at least one audio object. The object initializer 4000B may obtain the source location and obtain, based on the source location, the rescale offset 4002A (and potentially, the rescale factor 4002B), which again is output as metadata to MPAE processor 4800.

The renderer initializer 26 may further include a channel-based audio initializer 4000C that the renderer initializer 26 may invoke when the audio bitstream 21 indicates that the ambisonic audio elements 15 include at least one channel-based audio element. The object initializer 4000B may obtain the source location and obtain, based on the source location, the rescale offset 4002A (and potentially, the rescale factor 4002B), which again is output as metadata to MPAE processor 4800.

In each instance, the MPAE processor 4800 may operate as described below to render speaker feeds 25 that are potentially better adapted to the playback location, thereby creating the more immersive user experience. The process of obtaining this additional metadata (e.g., the rescale offset 4002A and the rescale factor 4002B) is described below with respect to FIG. 15, while FIG. 16 shows an example of MPAE processor 4800 in more detail.

In other words, when performing automatic rescaling of an XR scene, it may be important to determine what point of origin to use when applying the rescaling translation to the position of the audio source elements (which is another way to refer to ambisonic audio elements 15). Contextual understanding of the XR playback space (which is another way to refer to the playback location) should be used to determine if an anchor position is used as the new origin for rescaling or if other points of origin are used. Other points could be the virtual world coordinate origin, the real world playback space origin, or the listener position 1396. An offset relative to the new origin is applied to the ambisonic audio elements 15 while performing the rescaling, as discussed throughout this disclosure.

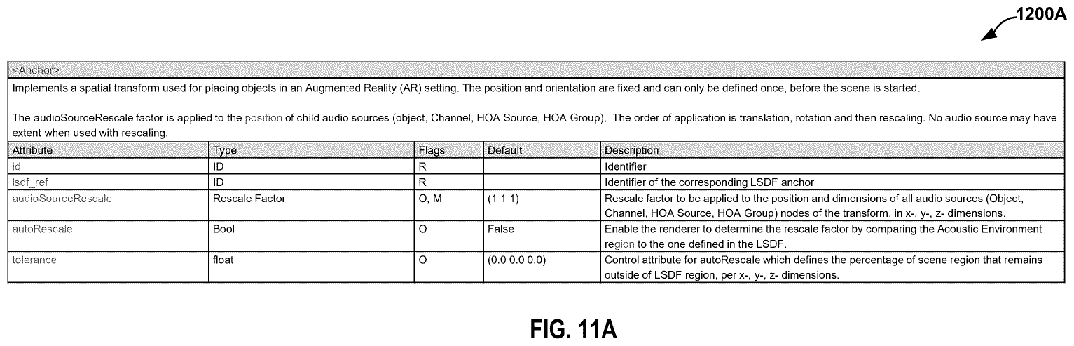

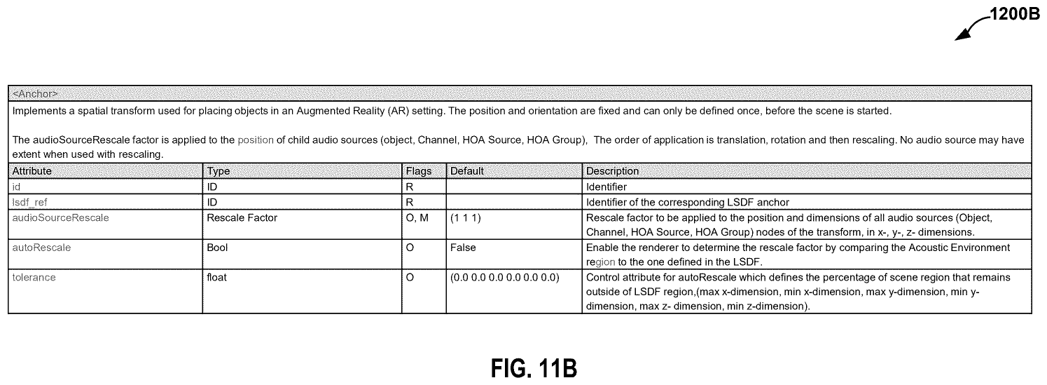

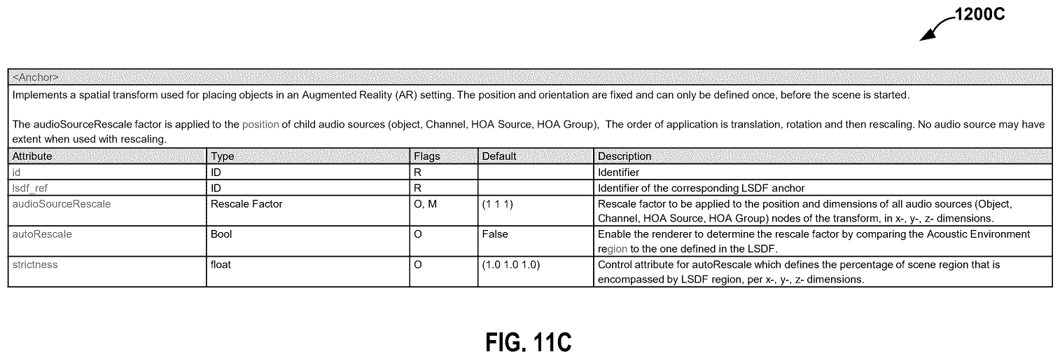

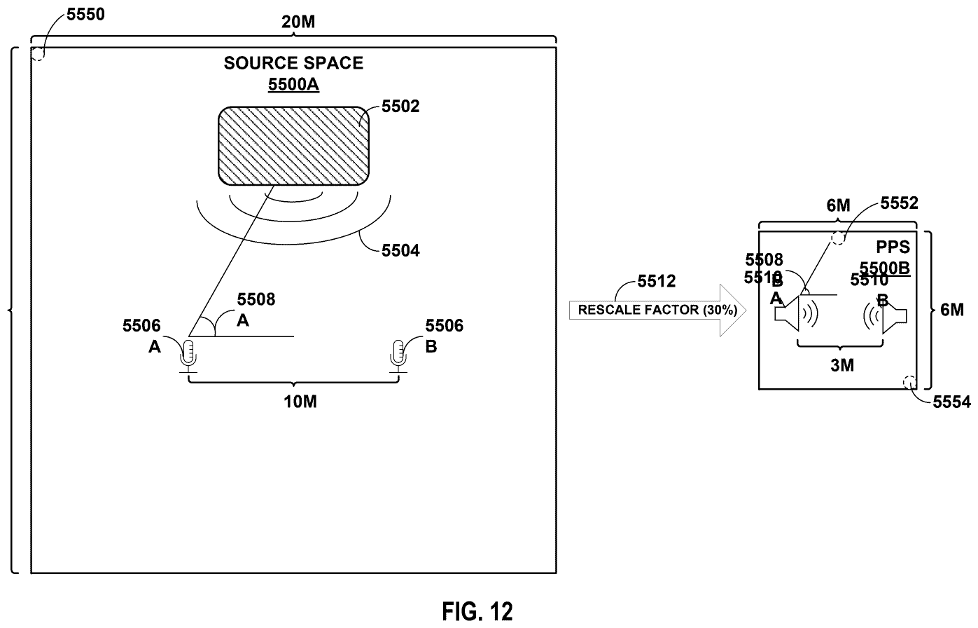

Utilizing the syntax elements described above with respect to FIGS. 11A-11C, various aspects of the techniques may enable MPEA processor 4800 to perform auto rescale per the following:

During the initialization of the MP-HOA stage, the HOA Source positions are rescaled by the bitstream parameter audioSourceRescale. When the HOA Group has a parent anchor and autoRescale is set to TRUE in the parent anchor, then the HOA Sources positions are rescaled automatically. Bounding boxes, R_v and R_1, are obtained respectively for the HOA Group region defined in the virtual scene, and for the physical listener space where the playback is to occur. Each box has N_boxdim sides corresponding to height, width, and depth. The max and min values for each region dimension are also obtained. The tolerance values set the percentage of R_v that remains outside of R_1 and are used to limit the amount of automatic rescaling performed. The process for automatically determining the rescaling factors is as follows:

```
    determine_rescale(R_v, R_1, tolerance) {
    for (i = 0; i < N_boxdim; i++) {
    rescale[i] = (R_(1_max)[i] − R_(1_min)[i]) /
    ((R_(v_max)[i] * (1 − tolerance[i*2]))
− R_(v_min)[i] * (1 − tolerance[i*2+1]);
    if (rescale[i] > 1.0) {rescale[i] = 1.0;}
  }
```

The rescale factors are applied to the source positions of the HOA Translator, with an offset so that the rescaling is performed with respect to the anchor position.

HOA source positions shall be rescaled by the bitstream parameter audioSourceRescale. When the HOA Group has a parent anchor and autoRescale is set to TRUE in the parent anchor, then the HOA Sources positions shall be rescaled automatically.

FIG. 15 illustrates a flowchart providing example operation of the renderer initializer shown throughout the examples of FIGS. 1A-14 in performing various aspect of the offset-based scaling techniques described in this disclosure. The renderer initializer 153 may first initialize or otherwise obtain one or more scaling factors (4100). For example, the renderer initializer 26 may initialize the rescale offset 4002A (which is another way to refer to the rescale offset 4002A) and the rescale factor 4002B to 0.0 and 1.0 respectively. The renderer initializer 26 may, as one example, initialize two 3D vectors, rescaleOffset and rescale, to store the offset for the dimensions and the scaling factor (respectively).

The renderer initializer 26 may next perform parent retrieval (4102). During parent retrieval, the renderer initializer 26 may retrieve the parent of the ambisonic audio elements 15 (e.g., an HOA group) to find the source space through a region associated with the, in this example, the HOA group (which is discussed in more detail above). Although described with respect to the HOA group, the renderer initializer 26 may perform parent retrieval with respect to a single ambisonic audio element 15 (which may not represent an HOA group, but any form of audio element or audio group, whether defined as HOA audio data or other scene-based audio data, audio object, and/or channel).

The renderer initializer 26 may then implement an anchor loop (4104) (e.g., when configured to use an anchor position, although as noted elsewhere different reference origins may be utilized). During the anchor loop (which is a loop because the anchor loop iterates over each of the ambisonic audio elements 15), the renderer initializer 26 may find the source space through a region associated with the respective ambisonic audio elements 15 (which again assumes by way of example the HOA group, but should not be limited to HOA audio data or other scene-based audio data). For each anchor, the renderer initializer 26 may verify that the name of the associated one of the ambisonic audio elements 15 matches the name of the parent, and verify if auto-rescale is enabled.

After completing the anchor loop (and verifying that the names match), the renderer initializer 26 may next perform geometry retrieval (4106). During geometry retrieval, the renderer initializer 26 may retrieve the current region and all geometry associated with the scene. After retrieving the current region and all geometry associated with the scene, the renderer initializer 26 may perform a geometry loop (4108) in which the renderer initializer 26 may loop over all the geometries to identify the region for the ambisonic audio elements 15 (e.g., HOA groups) and the region for the listener space.

The renderer initializer 26 may then calculate the rescale offset 4002A (4110) based on the reference origin of the ambisonic audio elements 15. The reference origin in this example may refer to the anchor position, but in other examples, the renderer initializer 26 may be configured to select the listener space origin (e.g., when no anchor point is defined), a listener position 1396, or the virtual world origin.

Following and/or concurrent to calculation of the rescale offset 4002A, the renderer initializer 26 may obtain bounding boxes and tolerance (4112). The renderer initializer 26 may obtain the tolerance level, retrieve the parent of the geometry, and obtain the bounding boxes of both the listener space and the audio element region.

The renderer initializer 26 may proceed to calculate or otherwise obtain the rescale factor 4002B (4114). When obtaining the rescale factor 4002B, the renderer initializer 26 may loop through the bounding box of the region, calculating a new scaling factor 4002B and offset for each dimension (e.g., x, y, z). The renderer initializer 26 may calculate or otherwise obtain the rescale factor 4002B based on the ration of the dimension to the listener space to the audio element region, adjusted by the tolerance level. The renderer initializer 26 may be configured to cap or otherwise limit the scaling factor to 1.0.

The renderer initializer 26 may next apply the rescale factor 4002B (4116), where the renderer initializer 26 adjusts the ambisonic audio elements 15 based on the final rescale factor 4002B and the rescale offset 4002A. In one example, the renderer initializer 26 may subtract the rescale offset 4002A (e.g., rescaleOffset_x, rescaleOffset_y, rescaleOffset_z) from the source coordinate for the audio element 15. The renderer initializer 26, in this example, may multiple the result by the corresponding (e.g., for each x, y, z dimension) rescale factor 4002B, and adding the corresponding (e.g., for each x, y, z dimension) back to the resealed coordinate. More details regarding obtaining and applying the rescale factor are described below in more detail with respect to the above noted U.S. patent application Ser. No. 18/045,839, entitled “SCALING AUDIO SOURCES IN EXTENDED REALITY SYSTEMS,” filed Oct. 12, 2022. The renderer initializer 26 may next output the rescaled audio element (4118) as an adjusted audio element.

FIGS. 7A-7C are diagrams illustrating example operation of the extended reality system shown in the example of FIGS. 1A and 1B in performing various aspects of the tolerance modified rescale techniques. Referring first to the example of FIG. 7A, a real world space 801A is shown in which the scene manager 23 of extended reality system 10 (shown in the example of FIGS. 1A and/or 1B) obtains a tolerance 50 indicating that strictness is 100% (in at least two of three dimensions, i.e., x-axis and y-axis, given that the depth—z-axis—is not shown). Strictness may be defined as one (1) minus tolerance 50 (or, in other words, 1−tolerance). Strictness may represent the percentage of the source location that is encompassed by the real world space.

With 100% strictness, there is no tolerance (0%) for a vertical or height axis (e.g., y-axis), an object 802 (which in this example is depicted as a sofa) is excluded from the real world space and the source location 804A is restricted to the top of object 802. While source location 804A is larger than real world space 801A (meaning, in this example, extending towards a floor of real world space 801A), the scene manager 23 may adapt audio elements to be above object 802 due to a potential incomplete or irregular representation of real world space 801A due to object 802.

In the example of FIG. 7B, real world space 801B represents a physical location in which extended reality system 10 is configured to reproduce an audio soundfield represented by audio bitstream 21. In this example, strictness is set to 50% while tolerance is also at 50%, which results in source location 804B being restricted to 50% of object 802, resulting in source location 804B being restricted to 50% of the height of object 802.

In the example of FIG. 7C, real world space 801C represents a physical location in which extended reality system 10 is configured to reproduce an audio soundfield represented by audio bitstream 21. In this example, strictness is set to 0% while tolerance is also at 1000%, which results in source location 804C being restricted to 0% of object 802, resulting in source location 804C being restricted to 0% of the height of object 802. The scene manager 23 may not adapt source location 804C, resulting in the source dimension (i.e., y-axis) being the same and not scaled due to a tolerance 50 defined as 100%.

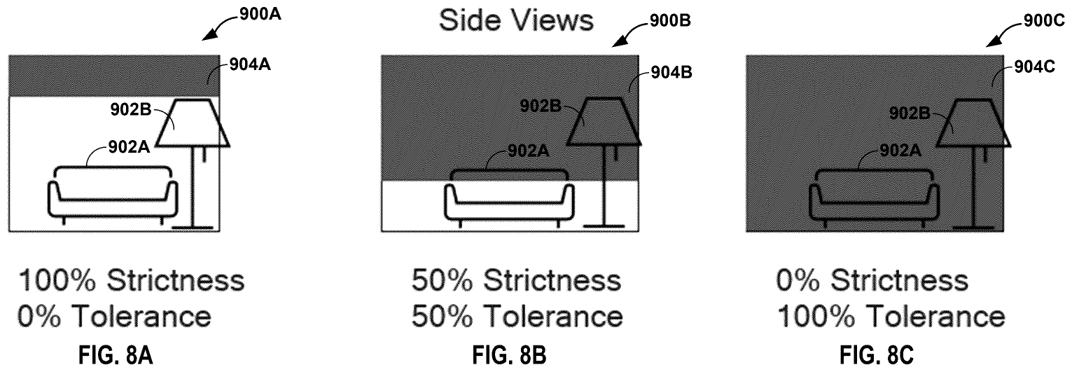

FIGS. 8A-8C are additional diagrams illustrating example operation of the extended reality system shown in the example of FIGS. 1A and 1B in performing various aspects of the tolerance modified rescale techniques. Referring first to the example of FIG. 8A, a real world space 900A is shown in which the scene manager 23 of extended reality system 10 (shown in the example of FIGS. 1A and/or 1B) obtains a tolerance 50 indicating that strictness is 100% (in at least two of three dimensions, i.e., x-axis and y-axis, given that the depth—z-axis—is not shown). Strictness may be defined as one (1) minus tolerance 50 (or, in other words, 1−tolerance). Strictness may represent the percentage of the source location that is encompassed by the real world space.

With 100% strictness, there is no tolerance (0%) for a vertical or height axis (e.g., y-axis), an object 902A (which in this example is depicted as a sofa) and an object 902B (which in this example is a floor lamp) is excluded from the real world space and the source location 904A is restricted to the top of object 902B (which refers to the tallest object 902A and/or 902B). While source location 904A is larger than real world space 900A (meaning, in this example, extending towards a floor of real world space 900A), the scene manager 23 may adapt audio elements to be above object 902B due to a potential incomplete or irregular representation of real world space 900A due to object 902B.

In the example of FIG. 8B, real world space 900B represents a physical location in which extended reality system 10 is configured to reproduce an audio soundfield represented by audio bitstream 21. In this example, strictness is set to 50% while tolerance is also at %50, which results in source location 904B being restricted to 50% of object 902B, resulting in source location 904B being restricted to 50% of the height of object 902B.

In the example of FIG. 8C, real world space 900C represents a physical location in which extended reality system 10 is configured to reproduce an audio soundfield represented by audio bitstream 21. In this example, strictness is set to 0% while tolerance is also at %1000, which results in source location 904C being restricted to 0% of object 902B, resulting in source location 904C being restricted to 0% of the height of object 902B. The scene manager 23 may not adapt source location 904C, resulting in the source dimension (i.e., y-axis) being the same and not scaled due to a tolerance 50 defined as 100%.

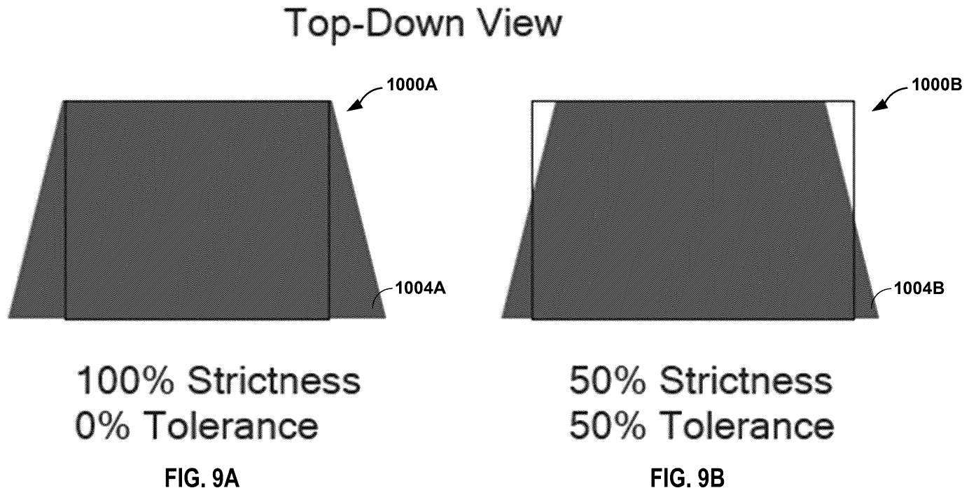

FIGS. 9A and 9B are further diagrams illustrating example operation of the extended reality system shown in the example of FIGS. 1A and 1B in performing various aspects of the tolerance modified rescale techniques. Referring first to the example of FIG. 9A, a real world space 1000A is shown in which the scene manager 23 of extended reality system 10 (shown in the example of FIGS. 1A and/or 1B) obtains a tolerance 50 indicating that strictness is 100% (in at least two of three dimensions, i.e., x-axis and y-axis, given that the depth—z-axis—is not shown).

In this example, soundfield representation generator 302 specifies tolerance 50 as a min/max of three dimensions, where in this example, the min/max is defined differently for the height dimension relative to the width dimension to accommodate slanting walls. In the example of FIG. 9A, the min/max for the width dimension at the maximum top height is different than the min/max for the width dimension at the minimum floor height. The scene manager 23 may generate real world space 1000A in view of the rescale factor as modified by tolerance 50% for source location 1004A.

With 100% strictness, there is no tolerance (0%) for a vertical or height axis (e.g., y-axis), and source location controls in which case the soundfield extends beyond the walls of real world space 900A by 100% leaving some extent of the soundfield inaccessible within real world space 1000A. In this example, source location includes sloping and/or slanted lines in a polyhedron configuration.

Referring next to the example of FIG. 9B, real world space 1000B represents a physical location in which extended reality system 10 is configured to reproduce an audio soundfield represented by audio bitstream 21. In this example, strictness is set to 50% while tolerance is also at 50%, which results in source location 1004B being restricted to 50% of real world space 1000B (meaning, resulting in source location 1004B being restricted to 50% of the width of real world space 1000B). In this example, source location 1004B is constrained by 50% of real world space 1000B where the beginning (from the floor) of source location 1004B extends only 50% outside of real world space 1000B.

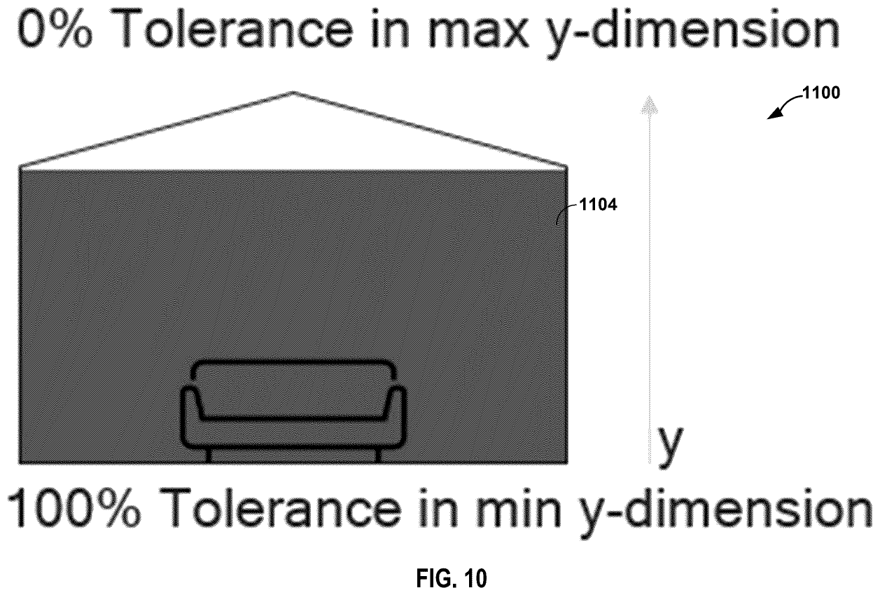

FIG. 10 is yet another diagram illustrating example operation of the extended reality system shown in the example of FIGS. 1A and 1B in performing various aspects of the tolerance modified rescale techniques. Real world space 1100 represents a physical location/space 1104 in which extended reality system 10 is configured to reproduce an audio soundfield represented by audio bitstream 21. In this example, tolerance is set to 0% for the max y-dimension (height) and 100% for the min y-dimension, allowing for variation between min/max in the y-dimension.

FIGS. 11A-11C are diagrams illustrating syntax tables for enabling various aspects of the tolerance modified rescale techniques. Syntax table 1200A shown in the example of FIG. 11A provides syntax elements (i.e., id, lsdf_ref, audioSourceRescale, autoRescale, and tolerance in this example). Syntax table 1200A provides syntax elements for implementing/controlling a spatial transform used for placing objects or other audio elements in an augmented reality (AR) setting (or other XR settings), where the position and orientation are fixed and can only be defined once, before the scene is started.

Id refers to an identifier, while lsdf_ref refers to an identifier of the corresponding LSDF anchor. audioSourceRescale refers to the rescale factor to be applied to the position and dimension of all audio sources (Object, Channel, HOA Source, HOA Group) nodes of the transform in x-, y-, and z-dimension. autoRescale refers to a Boolean to enable the renderer to determine the rescale factor by comparing the Acoustic Environment region to the one defined in the LSDF, while the tolerance refers to a control attribute for autoRescale which defines the percentage of the scene region that remains outside of LSDF region per x-, y-, and z-dimensions.

Syntax table 1200B shown in the example of FIG. 11B is similar to syntax table 1200A except the tolerance refers to a control attribute which defines the percentage of scene region that remains outside of LSDF region (max/min x-direction, max/min y-dimension, and max/min z-dimension). Syntax table 1200C shown in the example of FIG. 11C is similar to syntax tables 1200A and 1200B except the tolerance is replace with strictness (which may be defined in the x-, y-, and z-dimensions or a min/max for each of the x-, y-, and z-dimensions). For example, the various syntax elements may be denoted as follows:
audioSourceRescaleX This value is the rescale factor applied to the Cartesian position of audio element along the x dimension in metres.
audioSourceRescaleY This value is the rescale factor applied to the Cartesian position of audio element along the y dimension in metres.
audioSourceRescaleZ This value is the rescale factor applied to Cartesian position of audio element along the z dimension in metres.
autoRescale This value enables the renderer to determine the rescale factor by comparing the audio element acoustic environment (source space) region defined in the LSI (playback region/dimensions).
toleranceXMax This value represents the percentage of source region that remains outside of the listener region with respect to the source region's x dimension maximum.
toleranceXMin This value represents the percentage of source region that remains outside of the listener region with respect to the source region's x dimension minimum.
toleranceYMax This value represents the percentage of source region that remains outside of the listener region with respect to the source region's y dimension maximum.
toleranceYMin This value represents the percentage of source region that remains outside of the listener region with respect to the source region's y dimension minimum.
toleranceZMax This value represents the percentage of source region that remains outside of the listener region with respect to the source region's z dimension maximum.
toleranceZMin This value represents the percentage of source region that remains outside of the listener region with respect to the source region's z dimension minimum.

The following table defines how to obtain the audioSourceRescale:

In Table 104, the syntax of GetAudioSourceRescale( ) is defined.

TABLE
Syntax of GetAudioSourceRescale( )

| | No. of | |
|---|---|---|
| Syntax | bits | Mnemonic |
| audioSourceRescale = GetAudioSource Rescale( ) | | |
| { | | |
| for d = (0:2) { | var | vlclbf |
| audioSourceRescale[d] = LUT(decimalCode); | | |
| } | | |
| return audioSourceRescale; | | |
| } | | |

audioSourceRescale Rescale factors used to modify the position of audio elements.

FIG. 1B is a block diagram illustrating another example system 100 configured to perform various aspects of the techniques described in this disclosure. The system 100 is similar to the system 10 shown in FIG. 1A, except that the audio renderers 22 shown in FIG. 1A are replaced with a binaural renderer 102 capable of performing binaural rendering using one or more HRTFs or the other functions capable of rendering to left and right speaker feeds 103.

The audio playback system 16B may output the left and right speaker feeds 103 to headphones 104, which may represent another example of a wearable device and which may be coupled to additional wearable devices to facilitate reproduction of the soundfield, such as a watch, the VR headset noted above, smart glasses, smart clothing, smart rings, smart bracelets or any other types of smart jewelry (including smart necklaces), and the like. The headphones 104 may couple wirelessly or via wired connection to the additional wearable devices.

Additionally, the headphones 104 may couple to the audio playback system 16 via a wired connection (such as a standard 3.5 mm audio jack, a universal system bus (USB) connection, an optical audio jack, or other forms of wired connection) or wirelessly (such as by way of a Bluetooth™ connection, a wireless network connection, and the like). The headphones 104 may recreate, based on the left and right speaker feeds 103, the soundfield represented by the ambisonic coefficients 11. The headphones 104 may include a left headphone speaker and a right headphone speaker which are powered (or, in other words, driven) by the corresponding left and right speaker feeds 103.

Although described with respect to a VR device as shown in the example of FIGS. 5A and 5B, the techniques may be performed by other types of wearable devices, including watches (such as so-called “smart watches”), glasses (such as so-called “smart glasses”), headphones (including wireless headphones coupled via a wireless connection, or smart headphones coupled via wired or wireless connection), and any other type of wearable device. As such, the techniques may be performed by any type of wearable device by which a user may interact with the wearable device while worn by the user.

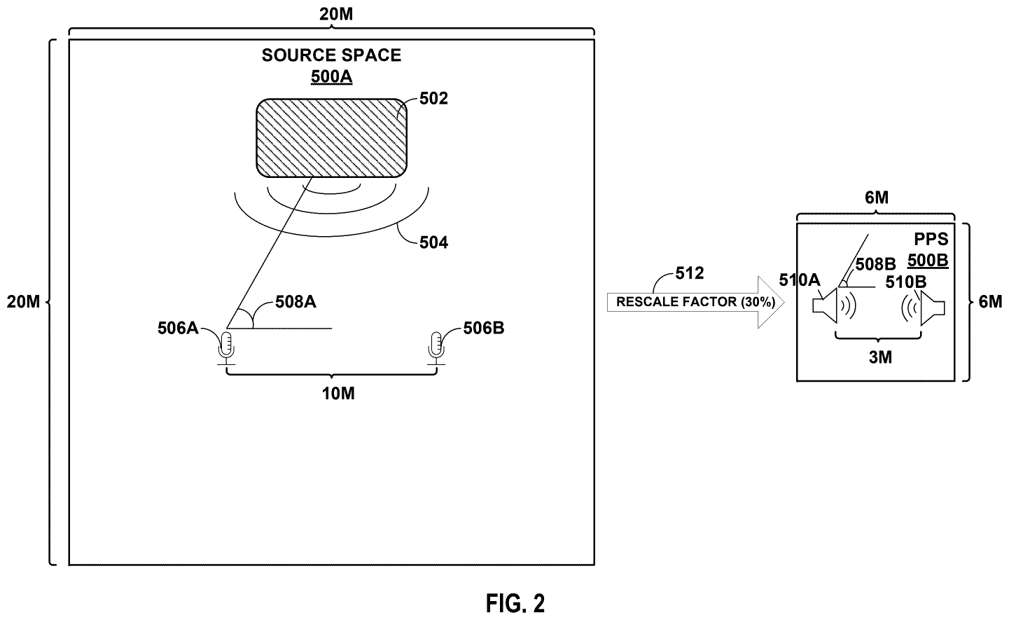

FIG. 2 is a block diagram illustrating example physical spaces in which various aspects of the rescaling techniques are performed in order to facilitate increased immersion while consuming extended reality scenes. In the example of FIG. 2, a source space 500A and a physical playback space (PPS) 500B is shown.

The source space 500A represents a concert venue (in this example) from which a stage 502 emits an audio soundfield 504 via loudspeakers (which are not shown in the example of FIG. 2 for ease of illustration purposes). The source space 500A also includes microphones 506A and 506B (“microphones 506”) that capture audio data representative of the audio soundfield 504. The content capture device 300 may capture the audio data representative of the audio soundfield 504 in various audio formats, such as a scene-based format (that may be defined via HOA audio formats), object-based formats, channel-based formats, and the like.

The soundfield representation generator 302 may generate, based on the audio data, the audio bitstreams 21 that specifies audio elements (in one or more of the audio formats noted above). The soundfield representation generator 302 may specify, in the audio bitstreams 21, the above noted syntax elements, such as the rescale syntax element that specifies a rescale factor to translate a position (or, in other words, location) of audio elements with respect to (often denoted as “w.r.t.”) the associated audio element and an auto rescale syntax element that specifies whether or not (e.g., a Boolean value) to generate a rescale factor based on environment dimensions (e.g., the dimensions of PPS 500B).

In the example of FIG. 2, the source space 500A is square with dimensions of 20 M in width and 20 M in length. Although not shown, the source space 500A may also include a height dimension (e.g., 20 M). The soundfield representation generator 302 may specify, in the audio bitstream 21, one or more syntax elements that specify one or more of the width, space, and/or height of the source space 500A. The soundfield representation generator 302 may specify the one or more syntax elements that specify one or more of the width, space, and/or height of the source space 500A using any form of syntax elements, including referential syntax elements that indicate one or more dimensions are the same as other dimensions of the source space 500A.

Microphones 506 may capture the audio data representative of the audio soundfield 504 in a manner that preserves an orientation, incidence of arrival, etc. of how the audio soundfield 504 arrived at each individual microphone 506. Microphones 506 may represent an Eigenmike® or other 3D microphone capable of capturing audio data in 360 degrees to fully represent the audio soundfield 504. In this respect, microphones 506 may represent an example of microphones 5 shown in the example of FIGS. 1A and 1B. Microphones 506 may therefore generate audio data reflective of a particular aspect of the audio soundfield 504, including an angle of incidence 508A (for microphone 506A, but there is also an angle of incidence 508B that is not shown for ease of illustration purposes with respect to microphone 506B).

In this way, the soundfield generator device 302 may generate the audio bitstream 21 to represent the audio elements captured by microphones 506 in 3D so that reproduction of the audio soundfield 504 may occur in 6DOF systems that provide a highly immersive experience. However, the PPS 500B has significantly different dimensions in that the dimensions for PPS 500B are 6 M for width and 6 M for length (and possibly 6 M for height or some other height).

In this example, the microphones in the source space 500A are located approximately 10 M apart, while the PPS 500B includes loudspeakers 510A and 510B (“loudspeakers 510”) spaced about, or approximately, 3 M apart. The audio playback system 16A may receive the audio bitstream 21 and parse (e.g., by invoking the audio decoding device 24) the audio elements representative of the audio soundfield 504 from the audio bitstream 21. The audio playback system 16A may also parse (e.g., by invoking the audio decoding device 24) the various syntax elements noted above with respect to the element relative rescale and auto rescale.

In initializing the audio playback system 16A for playback in the PPS 500B, the user of the content consumer device 14 may enter the dimensions (e.g., one or more of height, length, and width) of the PPS 500B via, as one example, a user interface or via having the user move about the PPS 500B. In some examples, the content consumer device 14 may automatically determine the dimensions of the PPS 500B (e.g., using a camera, an infrared sensing device, radar, lidar, ultrasound, etc.).

In any event, the audio playback system 16A may obtain both the dimensions of the source space 500A as well as the dimensions of the PPS 500B. The audio playback system 16A may next process the syntax elements for relative rescale and auto rescale to identify how and which audio elements specified in the audio bitstream 21 are to be rescaled. Assuming in this example that the audio soundfield 504 is to be rescaled as indicated by the syntax elements, the audio playback system 16A may be determined, based on the dimension of the source space 500A and the dimension of the PPS 500B, a rescale factor 512.

In the example of FIG. 2, the audio playback system 16A may determine the rescale factor as the width of the PPS 500B (6 M) divided by the width of the source space 500A (20 M), which results in a rescale factor of 0.3 or, in other words, 30%. The audio playback system 16A may next modify a location of the audio element representing the audio soundfield 504 captured by the microphone 506A to obtain a modified location of the audio soundfield 504 captured by the microphone 506A that is 30% closer to a reference location (e.g., a reference location for the center (0, 0, 0) of the XR scene, or in other words, an XR world) compared to a location of the microphone 506A relative of the center of the XR scene/world.

That is, the audio playback system 16A may multiply the location of the audio element representing the audio soundfield 504 as captured by the microphone 506A by the rescale factor to obtain the modified location of the audio element representing the audio soundfield 504 as captured by the microphone 506A. Given that the approximate dimensions of the source space 500A are uniform compared to the dimensions of the PPS 500B (meaning that the width and length of the source space 500A are linearly equivalent in proportion to the dimensions of the PPS 500B), the audio playback system 16A may apply the rescale factor to modify the location of the audio element representing the audio soundfield 504 as captured by the microphone 506A without altering an angle of incidence 508B during reproduction/playback by loudspeakers 510.

Using the scaling (which is another way to refer to rescaling) provided in accordance with various aspects of the techniques described in this disclosure, the audio playback system 16A (which is another way to refer to an XR playback system, a playback system, etc.) may improve reproduction of the soundfield to modify a location of audio sources (which is another way to refer to the audio elements parsed from the audio bitstream 21) to accommodate the size of the PPS 500B. In enabling such scaling, the audio playback system 16A may improve an immersive experience for the user when consuming the XR scene given that the XR scene more closely matches the playback space. The user may then experience the entirety of the XR scene safely within the confines of the permitted playback space. In this respect, the techniques may improve operation of the audio playback system 16A itself.

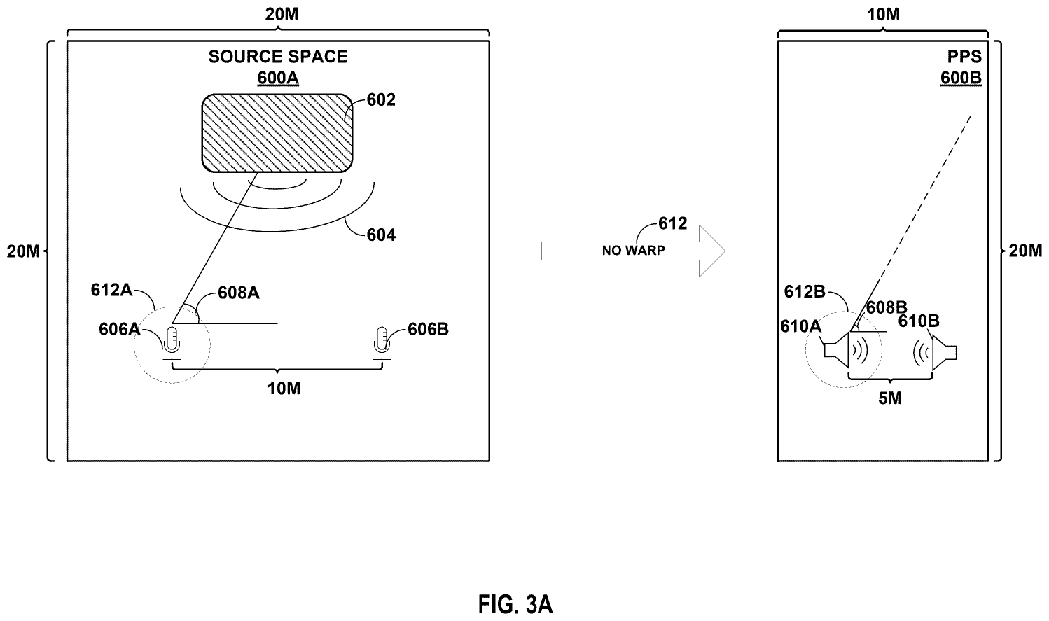

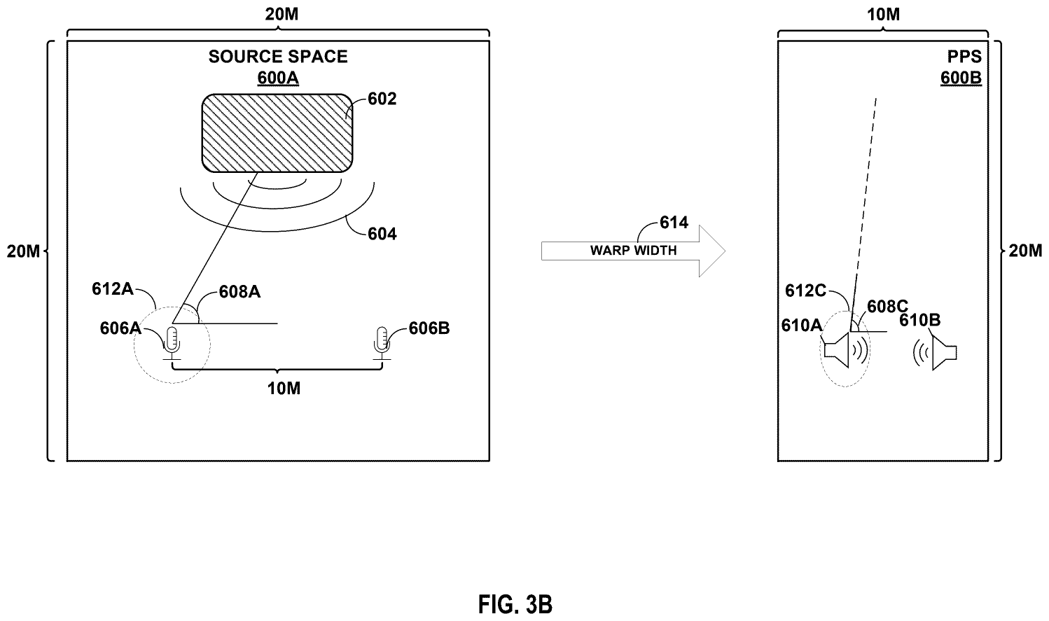

FIGS. 3A and 3B are block diagrams illustrating further example physical spaces in which various aspects of the rescaling techniques are performed in order to facilitate increased immersion while consuming extended reality scenes. Referring first to the example of FIG. 3A, a source space 600A is the same, or substantially similar to, the source space 500A in terms of dimensionality (20 M width by 20 M length), while a PPS 600B is different from the PPS 500B in terms of dimensionality (10 M width by 20 M length of PPS 600B compared to 6 M width by 6 M length of PPS 500B).

The audio playback system 16B may determine an aspect ratio of the source space 600A and an aspect ratio of the PPS 600B. That is, the audio playback system 16A may determine a source aspect ratio of the source space 600A based on the source width (20 M) and the source length (20 M), which results in the source aspect ratio (in this example) for the source space 600A equaling 1:1. The audio playback system 16A may also determine the aspect ratio for the PPS 600B based on the playback width of 10 M and a playback length of 20 M, which results in the playback aspect ratio (in this example) for the PPS 600B equaling 1:2.

The audio playback system 16 may determine a difference between the playback aspect ratio (e.g., 1:1) to the source aspect ratio (e.g., 1:2). The audio playback system 16 may compare the difference between the playback aspect ratio and the source aspect ratio to a threshold difference. The audio playback system 16 may, when the difference between the playback aspect ratio and the source aspect ratio exceeds the threshold difference, audio warping with respect to the audio element representing the audio soundfield 604 as captured by, in this example, a microphone 606A (which may represent an example of the microphone 506A, while a microphone 606B may represent an example of the microphone 506B).

More information regarding audio warping can be found in the following references: 1) a publication by Zotter, F. et al. entitled “Warping of the Recording Angle in Ambisonics,” from 1^{st} International Conference in Spatial Audio, Detmold, 2011; 2) a publication by Zotter, F. et al. entitled “Warping of 3D Ambisonic Recordings,” in Ambisonics Symposium, Lexington, 2011; and 3) a publication by Kronlachner, Matthias, et al. entitled “Spatial Transformations for the Enhancement of Ambisonic Recordings,” in Proceedings of the 2^{nd} International Conference on Spatial Audio, Erlangen, 2014. Audio warping may involve warping of the recording perspective and directional loudness modification of HOA.

That is, audio warping may involve application of the following mathematical equations in which a substitution is used to simplify subsequent warping curves in order to express the manipulation of the angle υ as follows:

$$μ = sin ( υ ) , original , \tilde{υ} = sin ( \tilde{υ} ) , warped ,$$

Warping towards and away from equator may occur using the following equation, which is another useful warping curve preserving the elevation of the equator. The following equation is neutral for β=0, pushes surround sound content away from the equator to the poles for β>0, or pulls it towards the equator for β<0:

$$\tilde{μ} = \{ \begin{matrix}\frac{( \vert β \vert - 1 ) \sqrt{{( ( \vert β \vert - 1 ) )}^{2} + 4 \vert β \vert {μ}^{2}}}{2 \vert β \vert μ} , & for β > 0 , \\ \frac{( 1 - \vert β \vert ) μ}{1 - \vert β \vert {μ}^{2}} , & for β < 0.\end{matrix}$$

The rescale factor discussed in this disclosure may be defined as β=−(rescale factor).

In instances where the rescale occurs in the height dimension, the audio playback system 16A may apply the following warping towards a pole as set forth in the following equation.

$$\tilde{μ} = \frac{μ + α}{1 + α μ}$$

The operator is neutral for α=0, and depending on the sign of a, it elevates or lowers the equator υ=0 of the original. In other words, if the height of the XR space is smaller, the audio playback system 16A may push sounds towards the sound pole and thus set α=−(height rescale factor).

The example of FIG. 3A shows how the audio playback system 16A may distort, through rescaling between different source and playback aspect ratios, reproduction of the audio soundfield 604 by loudspeakers 610A and 610B (which may represent examples of the loudspeakers 510 of the audio playback system 16A). As shown in the example of FIG. 3A, the angle of incidence 608A of the audio element representing the audio soundfield 604 as captured by the microphone 606A is centered on a stage 602 (which is another example of the stage 502 shown in the example of FIG. 2). However, the audio playback system 16A in rescaling the location of the audio element prior to reproduction by the loudspeakers 610 may result in reproduction that results in an angle of incidence 608B that presents the audio element as arriving from the far right.

In this example, the audio playback system 16A may compute a rescale factor 612 that includes no warping (“NO WARP”). A capture soundfield 612A is denoted by a dashed circle to show that the audio soundfield 604 was captured without warping. A reproduction soundfield 612B is shown as a dashed circle to denote that reproduction of the audio soundfield 604 (from the captured audio element) is also not warped.

Referring next to the example of FIG. 3B, the audio playback system 16A may perform, when the difference between the playback aspect ratio and the source aspect ratio exceeds the threshold difference, audio warping with respect to the audio element representing the audio soundfield 604 as captured by, in this example, a microphone 606A. In this example, the audio playback system 16A determines that the width is resulting in the difference between the source and playback aspect ratios. The audio playback system 16A may then perform, based on the difference in widths between the source space 600A and the PPS 600B, audio warping to preserve an angle of incidence 608A for the audio element representing the audio soundfield 604 as captured by the microphone 606A.

In performing the audio warping, the audio playback system 16A may (when the audio element is defined using higher order ambisonics—HOA—that conforms to a scene-based audio format having coefficients associated with a zero order and additional higher orders, such as first order, second order, etc. spherical basis functions) remove the coefficients associated with the zero-order spherical basis function (or, in other words, a zero-order basis function). The audio playback system 16A may next perform audio warping with respect to the modified higher order ambisonic coefficients (e.g., obtained after removing the coefficients associated with the zero-order basis function) to preserve the angle of incidence 608A for the audio element and obtain warped higher order ambisonic coefficients. The audio playback system 16A may then render, based on the modified location (due to, in this example, rescaling as discussed herein), the warped higher order ambisonic coefficients and the coefficients corresponding to the zero order ambisonic coefficients to obtain the one or more speaker feeds 25.

In the example of FIG. 3B, the audio playback system 16A may determine or otherwise obtain a rescale factor 614 that includes warping via the difference in width (but not lengths) between the source space 600A and the PPS 600B. The audio warping results in a reproduction soundfield 612C that is distorted to preserve the angle of incidence 608A in which the audio element is perceived as arriving from the center of the stage 602. The angle of incidence 608C is warped to preserve the angle of incidence 608A within the context of PPS 600B and given that reproduction of the audio soundfield 604 has been rescaled. In this respect, the audio playback system 16A may perform, based on the playback dimension and the source dimension, audio warping with respect to the audio element to preserve an angle of incidence 608A for the audio element (during reproducing in the context of the PPS 600B).

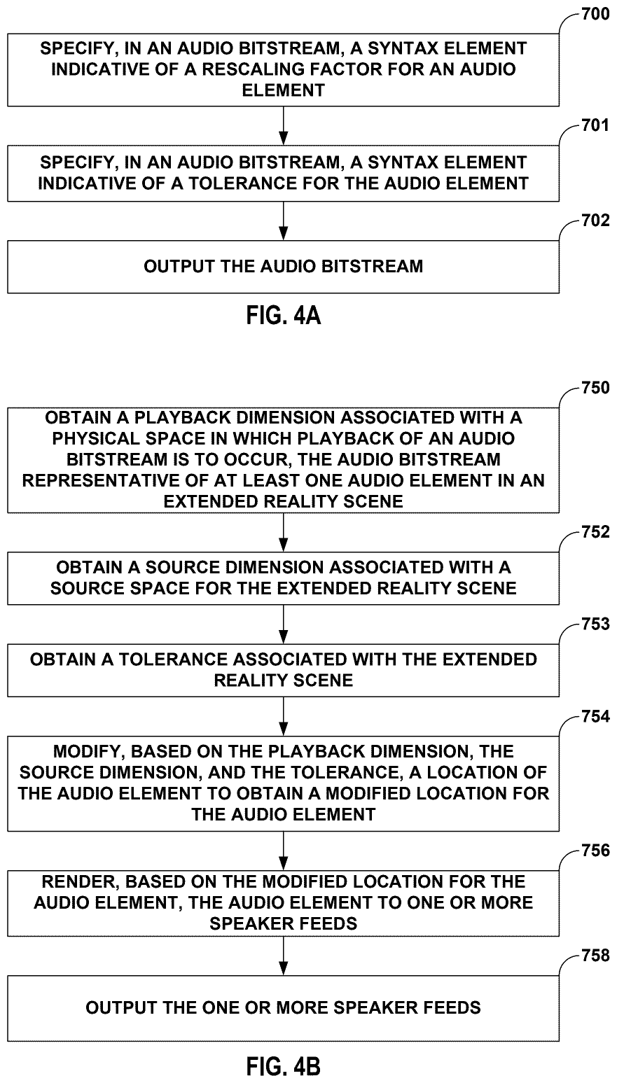

FIGS. 4A and 4B are flowcharts illustrating exemplary operation of an extended reality system shown in the example of FIG. 1 in performing various aspects of the rescaling techniques described in this disclosure. Referring first the example of FIG. 4A, the soundfield representation generator 302 may specify, in the audio bitstream 21, a syntax element indicative of a rescaling factor for the audio element (700). The rescaling factor may indicating how a location of the audio element is to be rescaled relative to other audio elements. The soundfield representation generator 302 may also specify a syntax element indicating that auto rescale is to be performed for a duration in which the audio element is present for playback. The soundfield representation generator 302 may then output the audio bitstream 21 (702).

Referring next to the example of FIG. 4B, the audio playback system 16A may receive the audio bitstream 21. The audio playback system 16A may obtain a playback dimension (one or more playback dimensions) associated with a physical space in which playback of the audio bitstream 21 is to occur (750). That is, the audio playback system 16A may interface with a user operating the audio playback system 16A to identify the playback dimensions (e.g., through an interactive user interface in which the user moves around the room to identify the playback dimensions) (and/or via a remote camera mounted to capture playback of the XR scene, via a head-mounted camera to capture playback/interactions of/with the XR scene, etc.).

In some instances, the audio playback system 16A may also extract, from the audio bitstream 21, syntax elements indicative of one or more source dimensions associated with a source space for the XR scene the syntax elements may be specified in a side channel of metadata or other extensions to the audio bitstream 21. Regardless, the audio playback system 16A may parse the source dimensions (e.g., as syntax elements) from the audio bitstream 21 or otherwise obtain the source dimensions associated with the source space for the XR scene (752).

The audio playback system 16A may then modify, based on the playback dimension and the source dimension, a location associated with the audio element to obtain a modified location for the audio element (754). In this respect, the audio decoding device 24 may parse the audio element from the audio bitstream 21, which is represented in the example of FIG. 1 as the ambisonic audio elements 15 (which may represent one or more audio elements). While described with respect to the ambisonic audio elements 15, various other audio data formats may be rescaled according to various aspects of the techniques, where other audio data formats may include object-based formats, channel-based formats, and the like.

In terms of performing audio rescaling, the audio playback system 16A may determine whether a difference between the source dimension and the playback dimension exceeds a threshold difference (e.g., more than 1%, 5%, 10%, 20%, etc. difference between the source dimension and the playback dimension). If the difference between the source dimension and the playback dimension exceeds the different threshold (defined, for example, as 1%, 5%, 10%, 20%, etc.), the audio playback system 16A may then determine the rescaling factor. The audio playback system 16A may determine the rescaling factor as a function of the playback dimension divided by the source dimension.

In instances of linear rescaling, the audio playback system 16A may determine the rescaling factor as the playback dimension divided by the source dimension. For example, assuming the source dimension is 20 M and the playback dimension is 6 M, the audio playback system 16A may compute the rescaling factor as 6 M/20 M, which equals 0.3 or 30% as the rescaling factor. The audio playback system 16A may apply the audio factor (e.g., 30%) when invoking the scene manager 23.

The audio playback system 16A may invoke the scene manager 23, passing the rescaling factor to the scene manager 23. The scene manager 23 may apply the rescaling factor when processing the audio elements extracted from the audio bitstream 21. The scene manager 23 may modify metadata defining a location of the audio element in the XR scene, rescaling metadata defining the location of the audio object to obtain the modified location of the audio object. The scene manager 23 may pass the modified location to the audio renderer 22, which may render, based on the modified location for the audio element, the audio element to the speaker feeds 25 (756). The audio renderers 22 may then output the speaker feeds 25 for playback by the audio playback system 16A (which may include one or more loudspeakers configured to reproduce, based on the speaker feeds 25, a soundfield (758).

The audio decoding device 24 may parse the above noted syntax elements indicating a rescale factor and an audio rescale is to be performed. When the rescale factor is specified in the manner noted above, the audio playback system 16A may obtain the rescale factor directly from the audio bitstream 21 (meaning, in this instance, without computing the rescale factor as a function of the playback dimension being divided by the source dimension). The audio playback system 16A may then apply the rescale factor in the manner noted above to obtain the modified location of the audio element.

When processing the syntax element indicative of auto rescale, the audio playback system 16A may refrain from rescaling audio elements associated with the auto rescale syntax element indicating that auto rescale is not to be performed. Otherwise, the audio playback system 16A may process audio elements associated with the audio rescale syntax element indicating that auto rescale is to be performed using various aspects of the techniques described in this disclosure for performing rescale. The auto rescale syntax element may configure the audio playback system 16A to continually apply the rescale factor to the associated audio element while the associated audio element is present in the XR scene.

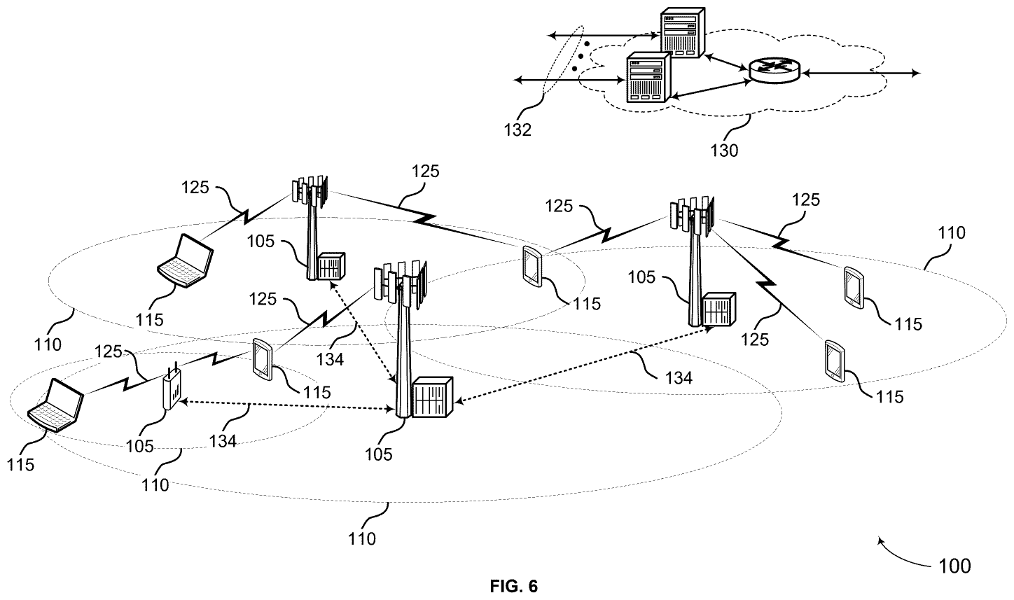

FIG. 6 illustrates an example of a wireless communications system 100 that supports audio streaming in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In examples of this disclosure, a UE 115 may be any of the audio sources described in this disclosure, including a VR headset, an XR headset, an AR headset, a vehicle, a smartphone, a microphone, an array of microphones, or any other device including a microphone or is able to transmit a captured and/or synthesized audio stream. In some examples, a synthesized audio stream may be an audio stream that that was stored in memory or was previously created or synthesized. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that exchange and/or use audio metadata indicating privacy restrictions and/or password-based privacy data to toggle, mask, and/or null various audio streams and/or audio sources as will be described in more detail below.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

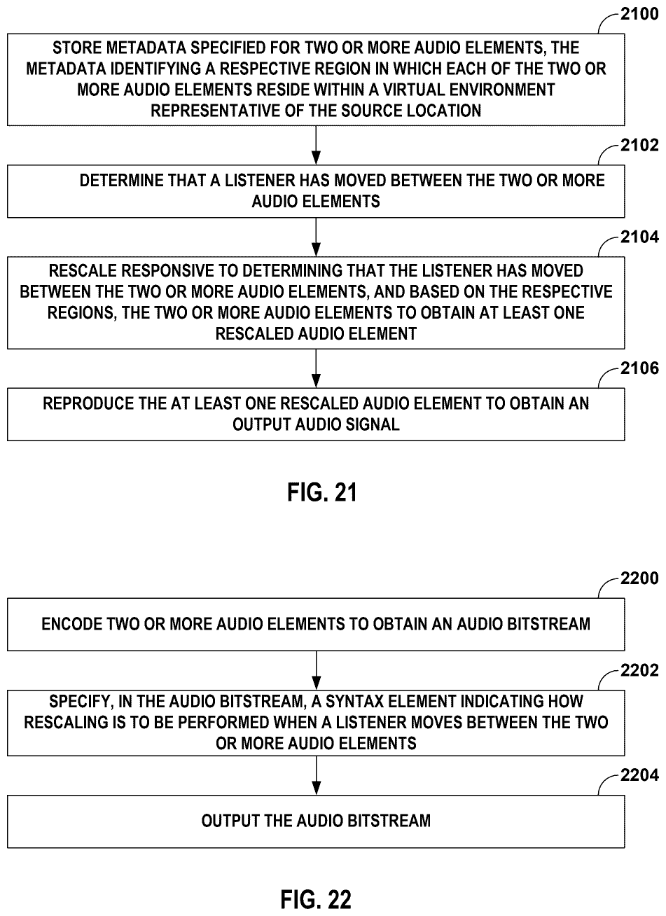

FIG. 21 is a flowchart illustrating example operation of the playback system shown in FIG. 1 in performing various aspects of the audio source rescaling techniques. The playback system 16A may store metadata specified for two or more audio elements, the metadata identifying a respective region in which each of the two or more audio elements reside within a virtual environment representative of the source location (2100). The playback system 16A may determine that a listener has moved between the two or more audio elements (2102), and rescale, responsive to determining that the listener has moved between the two or more audio elements and based on the respective regions, the two or more audio elements to obtain at least one resealed audio element (2104). The playback system 16A may then reproduce the at least one rescaled audio element to obtain an output audio signal (2106).

FIG. 22 is a flowchart illustrating example operation of the soundfield representation generator shown in FIG. 1 in performing various aspects of the audio source rescaling techniques. Soundfield representation generator 302 may first encode two or more audio elements to obtain an audio bitstream 21 (2200), and specify, in the audio bitstream 21, a syntax element indicating how rescaling is to be performed when a listener moves between the two or more audio elements (2202). Soundfield representation generator 302 may output the audio bitstream 21 (2204).

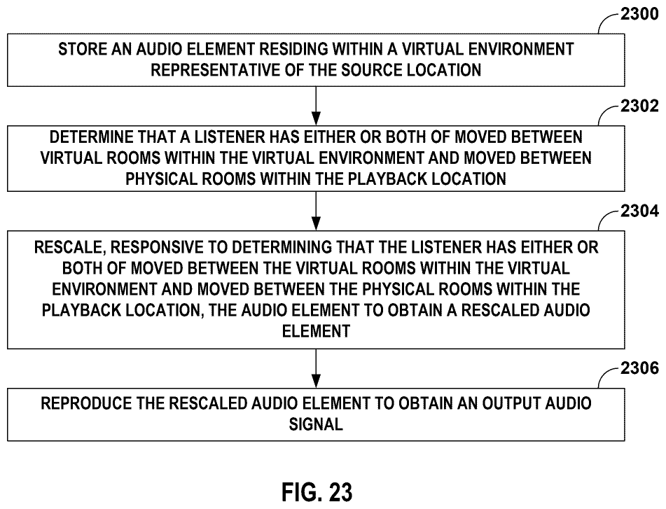

FIG. 23 is a flowchart illustrating another example operation of the playback system shown in FIG. 1 in performing various aspects of the audio source rescaling techniques. The playback system 16A may first store an audio element residing within a virtual environment representative of a source location (2300), and determine that a listener has either or both of moved between virtual rooms within the virtual environment and moved between physical rooms within the playback location (2302). The playback system 16A may next rescale, responsive to determining that the listener has either or both of moved between the virtual rooms within the virtual environment and moved between the physical rooms within the playback location, the audio element to obtain a rescaled audio element (2304), and reproduce the rescaled audio element to obtain an output speaker feeds 25 (and/or other audio signals) (2306).

In this way, various aspects of the techniques may enable the following examples.

Example 1A. A device configured to scale audio between a source location and a playback location, the device comprising: a memory configured to store metadata specified for two or more audio elements, the metadata identifying a respective region in which each of the two or more audio elements reside within a virtual environment representative of the source location; and processing circuitry communicatively coupled to the memory, and configured to: determine that a listener has moved between the two or more audio elements; rescale, responsive to determining that the listener has moved between the two or more audio elements and based on the respective regions, the two or more audio elements to obtain at least one rescaled audio element; and reproduce the at least one rescaled audio element to obtain an output audio signal.

Example 2A. The device of example 1A, wherein the processing circuitry is further configured to determine that the respective regions are different regions, and wherein the processing circuitry is configured to rescale, responsive to determining that the listener has moved between the two or more audio elements and determining that the respective regions are different regions, the two or more audio elements to obtain the at least one rescaled audio element.

Example 3A. The device of example 2A, wherein the processing circuitry is configured to rescale, responsive to determining that the listener has moved between the two or more audio elements and determining that the respective regions are different regions, the two or more audio elements with respect to the two or more audio elements into which the listener has moved.

Example 4A. The device of example 2A, wherein the processing circuitry is configured to rescale, responsive to determining that the listener has moved between the two or more audio elements and determining that the respective regions are different regions, the two or more audio elements with respect to the two or more audio elements from which the listener has moved away.

Example 5A. The device of any of examples 2A-4A, wherein the processing circuitry is configured to individually rescale the two or more audio elements differently than one another to obtain the at least one rescaled audio element.

Example 6A. The device of example 1A, wherein the processing circuitry is configured to determine that the respective regions overlap, and rescale, responsive to determining that the listener has moved between the two or more audio elements and determining that the respective regions overlap, the two or more audio elements to obtain corresponding two or more scaled audio elements.

Example 7A. The device of example 6A, wherein the processing circuitry is configured to rescale the two or more scaled audio elements a same amount.

Example 8A. The device of example 6A, wherein the processing circuitry is configured to rescale the two or more audio elements a same amount and refrain from individually rescaling the two or more audio elements.

Example 9A. The device of any of examples 1A-8A, wherein the processing circuitry is further configured to obtain, from a bitstream specifying the two or more audio elements, a syntax element indicating how rescaling should be performed when the listener moves between the two or more audio elements, and wherein the processing circuitry is configured to rescale, responsive to determining that the listener has moved between the two or more audio elements and based on the two or more regions and the syntax element, the two or more audio elements to obtain the at least one resealed audio element.

Example 10A. The device of any of examples 1A-9A, wherein the processing circuitry is further configured to obtain rescale factors that change over time during reproduction of the virtual scene, and wherein the processing circuitry is configured to dynamically rescale, responsive to determining that the listener has moved between the two or more audio elements, based on the two or more regions, and the rescale factors that change over time, the two or more audio elements to obtain the at least one rescaled audio element.

Example 10.1A. The device of any of examples 1A-10A, wherein the two or more audio elements comprise at least one audio object.

Example 10.2A. The device of any of examples 1A-10A, wherein the two or more audio elements comprise one or more sets of higher order ambisonic coefficients.

Example 11A. A method of scaling audio between a source location and a playback location, the method comprising: storing, by processing circuitry, metadata specified for two or more audio elements, the metadata identifying a respective region in which each of the two or more audio elements reside within a virtual environment representative of the source location; and determining, by the processing circuitry, that a listener has moved between the two or more audio elements; rescaling, by the processing circuitry, responsive to determining that the listener has moved between the two or more audio elements, and based on the respective regions, the two or more audio elements to obtain at least one rescaled audio element; and reproducing, by the processing circuitry, the at least one rescaled audio element to obtain an output audio signal.

Example 12A. The method of example 11A, further comprising determining that the respective regions are different regions, and wherein rescaling the two or more audio elements comprises rescaling, responsive to determining that the listener has moved between the two or more audio elements and determining that the respective regions are different regions, the two or more audio elements to obtain the at least one rescaled audio element.

Example 13A. The method of example 12A, wherein rescaling the two or more audio elements comprises rescaling, responsive to determining that the listener has moved between the two or more audio elements and determining that the respective regions are different regions, the two or more audio elements with respect to the two or more audio elements into which the listener has moved.

Example 14A. The method of example 12A, wherein rescaling the two or more audio elements comprises rescaling, responsive to determining that the listener has moved between the two or more audio elements and determining that the respective regions are different regions, the two or more audio elements with respect to the two or more audio elements from which the listener has moved away.

Example 15A. The method of any of examples 12A-14A, wherein rescaling the two or more audio elements comprises individually rescaling the two or more audio elements differently than one another to obtain the at least one rescaled audio element.

Example 16A. The method of example 11A, further comprising determining that the respective regions overlap, wherein rescaling the two or more audio elements comprises rescaling, responsive to determining that the listener has moved between the two or more audio elements and determining that the respective regions overlap, the two or more audio elements to obtain corresponding two or more scaled audio elements.

Example 17A. The method of example 16A, wherein rescaling the two or more audio elements comprises rescaling the two or more scaled audio elements a same amount.

Example 18A. The method of example 16A, wherein rescaling the two or more audio elements comprises rescaling the two or more audio elements a same amount and refrain from individually rescaling the two or more audio elements.

Example 19A. The method of any of examples 11A-18A, further comprising obtaining, from a bitstream specifying the two or more audio elements, a syntax element indicating how rescaling should be performed when the listener moves between the two or more audio elements, wherein rescaling the two or more audio elements comprises rescaling, responsive to determining that the listener has moved between the two or more audio elements and based on the two or more regions and the syntax element, the two or more audio elements to obtain the at least one rescaled audio element.

Example 20A. The method of any of examples 11A-19A, further comprising obtaining rescale factors that change over time during reproduction of the virtual scene, wherein rescaling the two or more audio elements comprises dynamically rescaling, responsive to determining that the listener has moved between the two or more audio elements, based on the two or more regions, and the rescale factors that change over time, the two or more audio elements to obtain the at least one rescaled audio element.

Example 20.1A. The method of any of examples 11A-19A, wherein the two or more audio elements comprise at least one audio object.

Example 20.2A. The method of any of examples 11A-20A, wherein the two or more audio elements comprise one or more sets of higher order ambisonic coefficients.

Example 21A. A non-transitory computer-readable storage medium having stored thereon instructions that, when executed, cause processing circuitry to: store metadata specified for two or more audio elements, the metadata identifying a respective region in which each of the two or more audio elements reside within a virtual environment representative of the source location; and determine that a listener has moved between the two or more audio elements; rescale, responsive to determining that the listener has moved between the two or more audio elements and based on the respective regions, the two or more audio elements to obtain at least one rescaled audio element; and reproduce the at least one rescaled audio element to obtain an output audio signal.

Example 1B. A device configured to encode an audio bitstream, the device comprising: a memory configured to store two or more audio elements, and processing circuitry coupled to the memory, and configured to: encode the two or more audio elements to obtain an audio bitstream; specify, in the audio bitstream, a syntax element indicating how rescaling is to be performed when a listener moves between the two or more audio elements; and output the audio bitstream.

Example 2B. The device of example 1B, wherein the syntax element indicates that rescaling is to be performed with respect to one of the two or more audio elements into which the listener moved.

Example 3B. The device of example 1B, wherein the syntax element indicates that rescaling is to be performed with respect to one of the two or more audio elements from which the listener moved.

Example 4B. The device of any of examples 1B-3B, wherein the syntax element comprises a first syntax element, and wherein the processing circuitry is further configured to: specify, in the audio bitstream, a second syntax element indicative of a rescaling factor for the audio element, the rescaling factor indicating how the source position of the audio element is to be rescaled relative to other audio elements within the playback location; specify, in the audio bitstream, a third syntax element indicative of a tolerance for applying the rescaling factor; and output the audio bitstream.

Example 5B. The device of example 4B, wherein the third syntax element defines a percentage of an audio scene region that remains outside of a playback region per width, height, and depth dimensions.

Example 6B. The device of example 4B, wherein the third syntax element defines a max and min percentage of the scene region that remains outside of a playback region per width, height, and depth dimensions.

Example 7B. The device of any of examples 4B-6B, wherein the processing circuitry is further configured to specify, in the audio bitstream, a fourth syntax element indicative of a center alignment, wherein the center alignment indicates that a center of the source dimension is to be aligned with a center of the playback dimension.

Example 8B. The device of any of examples 4B-7B, wherein the processing circuitry is further configured to specify, in the audio bitstream, a fifth syntax element indicative of a rotation, wherein the rotation indicates that the source dimension is to be rotate a front direction with respect to the playback dimension.

Example 9B. The device of any of examples 4B-8B, wherein the processing circuitry is further configured to specify, in the audio bitstream, a sixth syntax element indicating that auto rescale is to be performed for the audio element.

Example 9.1B. The device of any of examples 1B-9B, wherein the two or more audio elements comprise at least one audio object.

Example 9.2B. The device of any of examples 1B-9B, wherein the two or more audio elements comprise one or more sets of higher order ambisonic coefficients.

Example 10B. A method for encoding an audio bitstream, the method comprising: encoding two or more audio elements to obtain an audio bitstream; specifying, in the audio bitstream, a syntax element indicating how rescaling is to be performed when a listener moves between the two or more audio elements; and outputting the audio bitstream.

Example 11B. The method of example 10B, wherein the syntax element indicates that rescaling is to be performed with respect to one of the two or more audio elements into which the listener moved.

Example 12B. The method of example 10B, wherein the syntax element indicates that rescaling is to be performed with respect to one of the two or more audio elements from which the listener moved.

Example 13B. The method of any of examples 10B-12B, wherein the syntax element comprises a first syntax element, and wherein the method further comprises: specifying, in the audio bitstream, a second syntax element indicative of a rescaling factor for the audio element, the rescaling factor indicating how the source position of the audio element is to be rescaled relative to other audio elements within the playback location; specifying, in the audio bitstream, a third syntax element indicative of a tolerance for applying the rescaling factor; and outputting the audio bitstream.

Example 14B. The method of example 13B, wherein the third syntax element defines a percentage of an audio scene region that remains outside of a playback region per width, height, and depth dimensions.

Example 15B. The method of example 13B, wherein the third syntax element defines a max and min percentage of the scene region that remains outside of a playback region per width, height, and depth dimensions.

Example 16B. The method of any of examples 13B-15B, further comprising specifying, in the audio bitstream, a fourth syntax element indicative of a center alignment, wherein the center alignment indicates that a center of the source dimension is to be aligned with a center of the playback dimension.

Example 17B. The method of any of examples 13B-16B, further comprising specifying, in the audio bitstream, a fifth syntax element indicative of a rotation, wherein the rotation indicates that the source dimension is to be rotate a front direction with respect to the playback dimension.

Example 18B. The method of any of examples 13B-18B, further comprising specifying, in the audio bitstream, a sixth syntax element indicating that auto rescale is to be performed for the audio element.

Example 18.1B. The method of any of examples 10B-18B, wherein the two or more audio elements comprise at least one audio object.

Example 18.2B. The method of any of examples 10B-18B, wherein the two or more audio elements comprise one or more sets of higher order ambisonic coefficients.

Example 19B. A non-transitory computer-readable storage medium having stored thereon instructions that, when executed cause processing circuitry to: encode two or more audio elements to obtain an audio bitstream; specify, in the audio bitstream, a syntax element indicating how rescaling is to be performed when a listener moves between the two or more audio elements; and output the audio bitstream.

Example 1C. A device configured to scale audio between a source location and a playback location, the device comprising: a memory configured to store an audio element residing within a virtual environment representative of the source location; and processing circuitry communicatively coupled to the memory, and configured to: determine that a listener has either or both of moved between virtual rooms within the virtual environment and moved between physical rooms within the playback location; rescale, responsive to determining that the listener has either or both of moved between the virtual rooms within the virtual environment and moved between the physical rooms within the playback location, the audio element to obtain a rescaled audio element; and reproduce the rescaled audio element to obtain an output audio signal.

Example 2C. The device of example 1C, wherein the processing circuitry is further configured to: determine if the rescaled audio element is smaller than the audio element; and reduce, responsive to determining that the rescaled audio element is smaller than the audio element, a speed associated with the audio element to reduce a doppler effect.

Example 3C. The device of example 1C, wherein the processing circuitry is further configured to: determine if the rescaled audio element is smaller than the audio element; and increase, responsive to determining that the rescaled audio element is smaller than the audio element, a speed associated with the audio element to maintain a doppler effect.

Example 4C. The device of example 1C, wherein the processing circuitry is further configured to: determine if the rescaled audio element is smaller than the audio element; and increase, responsive to determining that the rescaled audio element is not smaller than the audio element, a speed associated with the audio element to increase a doppler effect.

Example 5C. The device of any of examples 1C-4C, wherein the processing circuitry is configured to: determine that the listener has moved between the physical rooms; and rescale, responsive to determining that the listener has moved between the physical rooms, the audio element to accommodate a new space of the physical rooms into which the listener moved and replace an old space of the physical rooms from which the listener moved.

Example 6C. The device of example 1C, wherein the processing circuitry is configured to: determine that the listener has moved between the virtual rooms; and rescale, responsive to determining that the listener has moved between the virtual rooms, the audio element to accommodate a new space of the virtual rooms into which the listener moved and replace an old space of the virtual rooms from which the listener moved.

Example 7C. The device of example 6C, wherein the new space of the virtual rooms comprises a new space defined with respect to a mini-map of the virtual rooms.

Example 8C. The device of any of examples 1C-7C, wherein the processing circuitry is further configured to identify a change in the playback location, and wherein the processing circuitry is configured to rescale, responsive to determining that the listener has either or both of moved between the virtual rooms and moved between the physical rooms, and based on the identified change in the playback location, the audio element to obtain the rescaled audio element.

Example 9C. The device of any of examples 1C-8C, wherein the processing circuitry is further configured to obtain rescale factors that change over time during reproduction of the virtual scene, and wherein the processing circuitry is configured to dynamically rescale, responsive to determining that the listener has either or both moved between the virtual rooms and moved between the physical rooms, and based on the rescale factors that change over time, the audio element to obtain the rescaled audio element.

Example 9.1C. The device of any of examples 1B-9B, wherein the audio element comprise at least one audio object.

Example 9.2C. The device of any of examples 1B-9B, wherein the audio element comprise one or more sets of higher order ambisonic coefficients.

Example 10C. A method for scaling audio between a source location and a playback location, the method comprising: storing an audio element residing within a virtual environment representative of the source location; determining that a listener has either or both of moved between virtual rooms within the virtual environment and moved between physical rooms within the playback location; rescaling, responsive to determining that the listener has either or both of moved between the virtual rooms within the virtual environment and moved between the physical rooms within the playback location, the audio element to obtain a rescaled audio element; and reproducing the rescaled audio element to obtain an output audio signal.

Example 11C. The method of example 10C, further comprising: determining if the rescaled audio element is smaller than the audio element; and reducing, responsive to determining that the rescaled audio element is smaller than the audio element, a speed associated with the audio element to reduce a doppler effect.

Example 12C. The method of example 10C, further comprising: determining if the rescaled audio element is smaller than the audio element; and increasing, responsive to determining that the rescaled audio element is smaller than the audio element, a speed associated with the audio element to maintain a doppler effect.

Example 13C. The method of example 10C, further comprising: determining if the rescaled audio element is smaller than the audio element; and increasing, responsive to determining that the resealed audio element is not smaller than the audio element, a speed associated with the audio element to increase a doppler effect.

Example 14C. The method of any of examples 10C-13C, wherein rescaling the audio element comprises rescaling, responsive to determining that the listener has moved between the physical rooms, the audio element to accommodate a new space of the physical rooms into which the listener moved and replace an old space of the physical rooms from which the listener moved.

Example 15C. The method of example 10C, wherein rescaling the audio element comprises rescaling, responsive to determining that the listener has moved between the virtual rooms, the audio element to accommodate a new space of the virtual rooms into which the listener moved and replace an old space of the virtual rooms from which the listener moved.

Example 16C. The method of example 15C, wherein the new space of the virtual rooms comprises a new space defined with respect to a minimap of the virtual rooms.

Example 17C. The method of any of examples 10C-16C, further comprising identifying a change in the playback location, wherein rescaling the audio element comprises rescaling, responsive to determining that the listener has either or both of moved between the virtual rooms and moved between the physical rooms, and based on the identified change in the playback location, the audio element to obtain the rescaled audio element.

Example 18C. The method of any of examples 10C-17C, further comprising obtaining rescale factors that change over time during reproduction of the virtual scene, wherein rescaling the audio element comprises dynamically rescaling, responsive to determining that the listener has either or both moved between the virtual rooms and moved between the physical rooms, and based on the rescale factors that change over time, the audio element to obtain the rescaled audio element.

Example 18.1C. The method of any of examples 10C-18C, wherein the two or more audio elements comprise at least one audio object.

Example 18.2C. The method of any of examples 10C-18C, wherein the two or more audio elements comprise one or more sets of higher order ambisonic coefficients.

Example 19C. A non-transitory computer-readable storage medium having stored thereon instructions that, when executed, cause processing circuitry to: store an audio element residing within a virtual environment representative of the source location; determine that a listener has either or both of moved between virtual rooms within the virtual environment and moved between physical rooms within the playback location; rescale, responsive to determining that the listener has either or both of moved between the virtual rooms within the virtual environment and moved between the physical rooms within the playback location, the audio element to obtain a rescaled audio element; and reproduce the rescaled audio element to obtain an output audio signal.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, the VR device (or the streaming device) may communicate, using a network interface coupled to a memory of the VR/streaming device, exchange messages to an external device, where the exchange messages are associated with the multiple available representations of the soundfield. In some examples, the VR device may receive, using an antenna coupled to the network interface, wireless signals including data packets, audio packets, visual packets, or transport protocol data associated with the multiple available representations of the soundfield. In some examples, one or more microphone arrays may capture the soundfield.

In some examples, the multiple available representations of the soundfield stored to the memory device may include a plurality of object-based representations of the soundfield, higher order ambisonic representations of the soundfield, mixed order ambisonic representations of the soundfield, a combination of object-based representations of the soundfield with higher order ambisonic representations of the soundfield, a combination of object-based representations of the soundfield with mixed order ambisonic representations of the soundfield, or a combination of mixed order representations of the soundfield with higher order ambisonic representations of the soundfield.

In some examples, one or more of the soundfield representations of the multiple available representations of the soundfield may include at least one high-resolution region and at least one lower-resolution region, and wherein the selected presentation based on the steering angle provides a greater spatial precision with respect to the at least one high-resolution region and a lesser spatial precision with respect to the lower-resolution region.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, including fixed function processing circuitry and/or programmable processing circuitry, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set), a robot, a vehicle (such as an automobile, farm equipment, an airplane, etc.). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device configured to scale audio between a source location and a playback location, the device comprising:
a memory configured to store metadata specified for two or more audio elements, the metadata identifying a respective region in which each of the two or more audio elements reside within a virtual environment representative of the source location; and
processing circuitry communicatively coupled to the memory, and configured to:
determine that a listener has moved between the two or more audio elements;
rescale, responsive to determining that the listener has moved between the two or more audio elements and based on the respective regions, the two or more audio elements to obtain at least one rescaled audio element; and
reproduce the at least one rescaled audio element to obtain an output audio signal.

2. The device of claim 1,
wherein the processing circuitry is further configured to determine that the respective regions are different regions, and
wherein the processing circuitry is configured to rescale, responsive to determining that the listener has moved between the two or more audio elements and determining that the respective regions are different regions, the two or more audio elements to obtain the at least one rescaled audio element.

3. The device of claim 2, wherein the processing circuitry is configured to rescale, responsive to determining that the listener has moved between the two or more audio elements and determining that the respective regions are different regions, the two or more audio elements with respect to the two or more audio elements into which the listener has moved.

4. The device of claim 2, wherein the processing circuitry is configured to rescale, responsive to determining that the listener has moved between the two or more audio elements and determining that the respective regions are different regions, the two or more audio elements with respect to the two or more audio elements from which the listener has moved away.

5. The device of claim 2, wherein the processing circuitry is configured to individually rescale the two or more audio elements differently than one another to obtain the at least one rescaled audio element.

6. The device of claim 1,
wherein the processing circuitry is configured to determine that the respective regions overlap, and
rescale, responsive to determining that the listener has moved between the two or more audio elements and determining that the respective regions overlap, the two or more audio elements to obtain corresponding two or more scaled audio elements.

7. The device of claim 6, wherein the processing circuitry is configured to rescale the two or more scaled audio elements a same amount.

8. The device of claim 6, wherein the processing circuitry is configured to rescale the two or more audio elements a same amount and refrain from individually rescaling the two or more audio elements.

9. The device of claim 1,
wherein the processing circuitry is further configured to obtain, from a bitstream specifying the two or more audio elements, a syntax element indicating how rescaling is to be performed when the listener moves between the two or more audio elements, and
wherein the processing circuitry is configured to rescale, responsive to determining that the listener has moved between the two or more audio elements and based on the respective regions and the syntax element, the two or more audio elements to obtain the at least one rescaled audio element.

10. The device of claim 1,
wherein the processing circuitry is further configured to obtain rescale factors that change over time during reproduction of the virtual environment, and
wherein the processing circuitry is configured to dynamically rescale, responsive to determining that the listener has moved between the two or more audio elements, based on the respective regions, and the rescale factors that change over time, the two or more audio elements to obtain the at least one rescaled audio element.

11. The device of claim 1, wherein the two or more audio elements comprise at least one audio object.

12. The device of claim 1, wherein the two or more audio elements comprise one or more sets of higher order ambisonic coefficients.

13. A method of scaling audio between a source location and a playback location, the method comprising:
storing, by processing circuitry, metadata specified for two or more audio elements, the metadata identifying a respective region in which each of the two or more audio elements reside within a virtual environment representative of the source location; and
determining, by the processing circuitry, that a listener has moved between the two or more audio elements;
rescaling, by the processing circuitry, responsive to determining that the listener has moved between the two or more audio elements, and based on the respective regions, the two or more audio elements to obtain at least one rescaled audio element; and
reproducing, by the processing circuitry, the at least one rescaled audio element to obtain an output audio signal.

14. The method of claim 13, further comprising determining that the respective regions are different regions, and
wherein rescaling the two or more audio elements comprises rescaling, responsive to determining that the listener has moved between the two or more audio elements and determining that the respective regions are different regions, the two or more audio elements to obtain the at least one rescaled audio element.

15. The method of claim 14, wherein rescaling the two or more audio elements comprises rescaling, responsive to determining that the listener has moved between the two or more audio elements and determining that the respective regions are different regions, the two or more audio elements with respect to the two or more audio elements into which the listener has moved.

16. The method of claim 14, wherein rescaling the two or more audio elements comprises rescaling, responsive to determining that the listener has moved between the two or more audio elements and determining that the respective regions are different regions, the two or more audio elements with respect to the two or more audio elements from which the listener has moved away.

17. The method of claim 14, wherein rescaling the two or more audio elements comprises individually rescaling the two or more audio elements differently than one another to obtain the at least one rescaled audio element.

18. The method of claim 13, further comprising determining that the respective regions overlap,
wherein rescaling the two or more audio elements comprises rescaling, responsive to determining that the listener has moved between the two or more audio elements and determining that the respective regions overlap, the two or more audio elements to obtain corresponding two or more scaled audio elements.

19. The method of claim 14, wherein rescaling the two or more audio elements comprises rescaling the two or more audio elements a same amount.

20. A non-transitory computer-readable storage medium having stored thereon instructions that, when executed, cause processing circuitry to:
store metadata specified for two or more audio elements, the metadata identifying a respective region in which each of the two or more audio elements reside within a virtual environment representative of a source location; and
determine that a listener has moved between the two or more audio elements;
rescale, responsive to determining that the listener has moved between the two or more audio elements and based on the respective regions, the two or more audio elements to obtain at least one rescaled audio element; and
reproduce the at least one rescaled audio element to obtain an output audio signal.
